(19) United States
(12) Patent Application Publication
(10) Pub. No.: US 2010/0261038 A1
(43) Pub. Date: Oct. 14, 2010

(54) COMPOSITE MAGNETIC MATERIAL FOR MAGNET AND METHOD FOR MANUFACTURING SUCH MATERIAL

(76) Inventors: Nobuyoshi Imaoka, Tokyo (JP); Masanori Abe, Tokyo (JP); Takashi Nakagawa, Tokyo (JP); Masaru Tada, Tokyo (JP)

Correspondence Address: BIRCH STEWART KOLASCH & BIRCH, PO BOX 747, FALLS CHURCH, VA, 22040-0747, US

(21) Appl. No.: 12/740,647

(22) PCT Filed: Oct. 31, 2008
(86) PCT No.: PCT/JP2008/069858

§ 371 Date: Apr. 29, 2010

(30) Foreign Application Priority Data
Nov. 2, 2007 (JP) 200--285815

(51) Int. Cl. G11B 5/62; B05D 3/00; B05D 5/00

(52) U.S. Cl. 428/800; 427/547; 427/127

(57) ABSTRACT

Provided is a composite magnetic material having high magnetic characteristics and high electrical resistivity to be used for a magnet, especially a composite magnetic material to be suitably used for a rotary motor magnet or the like which functions in a high frequency region. The composite magnetic material for the magnet is provided by covering the surface of a rare earth-iron-nitrogen based magnetic material with a ferrite based magnetic material.

### TECHNICAL FIELD

The present invention relates to a rare earth-iron-nitrogen based composite magnetic material for a magnet having high magnetic characteristics and a high electrical resistivity, and excelling in oxidation-resistant performance.

Composite magnetic materials for magnets are used for various types of actuators, voice coil motors, linear motors, rotors and stators of motors for rotary machines, magnetic field generating sources of medical apparatuses and metal sorting machines, magnetic field generating sources for analyzers such as VSM apparatuses, ESR apparatuses and accelerators, magnetron traveling wave tubes, OA devices such as printer heads and optical pickups, undulators, wigglers, retarders, magnet rolls, magnet chucks, various types of magnet sheets and the like. They are utilized especially for motors and electric generators whose rotation speed exceeds 500 rpm for driving cars such as electric cars, fuel cell cars and hybrid cars; machine tools; electric generators; motors for industrial machines such as various types of pumps; and motors for home electrical products such as air conditioners, refrigerators and cleaners.

### BACKGROUND ART

As high-performance rare earth based magnetic materials, metal magnet materials, for example, Sm—Co based magnets and Nd—Fe—B based magnets, are known (in the present invention, “a rare earth based magnetic material” is defined as a magnetic material containing a rare earth element, as seen in the materials described above). The former and the latter are broadly used, respectively, for the reason of high thermal stability, corrosion resistance and the like and for the reason of remarkably high magnetic characteristics, low costs, stability of raw material supply and the like. Rare earth magnets having high thermal stability and together high magnetic characteristics and of low raw material costs are nowadays demanded as actuators for electrical equipment and for various types of FAs and magnets for rotary machines.

Although metal magnet materials described above have recently been used for motors for driving cars, motors for air conditioners and the like from requirements for energy saving and space saving, since the metal based magnetic materials have low electrical resistivity, there actually arises a problem of loss due to eddy current generated in magnets. This tendency becomes more outstanding as a motion becomes higher in speed, that is, as the rotational frequency is higher in the case of motors, or as a generated electric field has a higher frequency (, the higher frequency is here defined as a frequency region of 500 rpm or higher and lower than 1.8 Mrpm (=30 kHz)). Due to this eddy current loss, heat is generated in magnets to cause a temperature rise and thereby demagnetization in some cases, giving a large obstacle to broader applications.

On the other hand, since oxide based magnet materials such as Ba ferrite have an electrical resistivity of 10¹⁰ μΩcm or more and have a much higher electrical resistivity than 100 μΩcm caused by, for example, Nd—Fe—B based magnets of metal based magnet materials, the oxide based magnet materials have no risk of loss due to eddy current as described above. However, since magnetic characteristics thereof are low, the oxide based magnet materials are unlikely to be used in recent year's devices, which are reduced in size and provide high performance.

Therefore, a magnet material is sought which has a higher electrical resistivity than metal magnet materials, for example, an electrical resistivity exceeding 2,000 μΩcm and more preferably 2,500 μΩcm, and besides has a higher performance than oxide based magnet materials, for example, a maximum energy product of 43 kJ/m³ or an intrinsic coercive force exceeding 0.5 T, which is at present the highest performance of ferrite magnets, or higher.

On the other hand, nitride based magnetic materials for magnets, which are known as intermediate existences between these metal magnet materials and oxide based magnet materials, are proposed as a new magnetic material meeting these requirements. However, in cases where these materials represented by rare earth-iron-nitrogen based magnetic materials (see PATENT DOCUMENT 1 or 2) are made into high-density magnetic materials, the electrical resistivity thereof is about 400 μΩcm and is not so high as compared with oxide based magnetic materials such as ferrite based magnetic materials. Therefore, the further high electrical resistivity is sought.

### PATENT DOCUMENT 1: Japanese Patent No. 2691034

### PATENT DOCUMENT 2: Japanese Patent No. 2703281

### DISCLOSURE OF THE INVENTION

### Problems to be Solved by the Invention

It is an object of the present invention to provide a novel and high performance nitride based composite magnetic material for a magnet, which can achieve a large magnetic force (=a maximum energy product) by exhibiting a higher magnetization than oxide based magnet materials and further can solve problems such as the above-mentioned eddy current loss by exhibiting a higher electrical resistivity than metal based magnet materials, by the use of a composite magnetic material in which a ferrite based magnetic material is coated on the powder surface of a rare earth-iron-nitrogen based magnetic material.

### Means for Solving the Problems

The present inventors have exhaustively studied on the utilization of a nitride for the purpose of obtaining a magnetic material for a magnet excellent in electrical characteristics, which has characteristics contrary to the characteristics of conventional magnetic materials, that is, a magnetic material for a magnet excellent in electrical characteristics, which simultaneously has both advantages of metal based magnetic materials and oxide based magnetic materials wherein the both advantages are a high magnetization and a high electrical resistivity capable of solving the problems of the eddy-current loss described above. As the result, the present inventors have found that in cases where a magnetic powder having a ferrite based magnetic material coating the surface of a rare earth-iron-nitrogen based magnetic material is used as a composite magnetic material for a magnet, the electrical insulation and the magnetic coupling (, as described later in detail) can be especially achieved, can be expected to improve the oxidation-resistant performance, and can provide permanent magnets exhibiting functions suitable to the purposes by subjecting the magnetic powder to various types of molding. And, the present inventors have achieved the present invention by controlling the composition, crystal structure, micostructure and particle diameter, and establishing the manufacturing method. Further, according to the present invention, although a rare earth based magnetic material coated with a ferrite based magnetic material is inferior to rare earth-iron-nitrogen based magnetic materials, it can also provide an improved electrical resistivity.

That is, the present invention is as follows.

(1) A composite magnetic material for a magnet, comprising a rare earth based magnetic material and a ferrite based magnetic material coated on a surface of the rare earth based magnetic material.
(2) The composite magnetic material for a magnet according to (1), wherein the ferrite based magnetic material is a soft magnetic ferrite.
(3) The composite magnetic material for a magnet according to (1) or (2), wherein the ferrite based magnetic material is a ferrite having a spinel structure.
(4) The composite magnetic material for a magnet according to any one of (1) to (3), wherein the ferrite based magnetic material has a thickness of 0.8 to 10,000 nm.
(5) The composite magnetic material for a magnet according to any one of (1) to (4), wherein the rare earth based magnetic material is a rare earth-iron-nitrogen based magnetic material.
(6) The composite magnetic material for a magnet according to (5), wherein the rare earth-iron-nitrogen based magnetic material is a magnetic material represented by the following general formula:

RₓFe_{(100-x-y)}N_{y}

wherein R is at least one of rare earth elements containing Y; and x and y satisfy 3 atomic %<x<30 atomic % and 1 atomic %<y<30 atomic %, respectively.
(7) The composite magnetic material for a magnet according to (6), wherein 0.01 to 50 atomic % of Fe in the general formula in (6) is substituted with at least one element selected from the group consisting of Co, Ni, B, Al, Ti, V, Cr, Mn, Cu, Zn, Ga, Zr, Nb, Mo, Pd, Ag, Cd, In, Sn, Hf, Ta, W, Ru, Re, Os, Ir, Pt, Pb, Bi, an alkali metal and an alkaline earth metal.
(8) The composite magnetic material for a magnet according to (6) or (7), wherein 50 atomic % or more of R in the general formula in (6) is Sm.
(9) The composite magnetic material for a magnet according to any one of (5) to (8), wherein a crystal structure of a main phase of the rare earth-iron-nitrogen based magnetic material is any one of the hexagonal crystal, the rhombohedral crystal and the tetragonal crystal.
(10) The composite magnetic material for a magnet according to any one of (5) to (9), wherein the rare earth-iron-nitrogen based magnetic material is a powder having an average particle diameter of 0.1 to 2,000 μm.
(11) The composite magnetic material for a magnet according to any one of (1) to (10), which is an exchange-spring magnet.
(12) The composite magnetic material for a magnet according to any one of (5) to (11), wherein a phase simultaneously containing R and oxygen in the interface between a layer composed of the ferrite based magnetic material and the rare earth-iron-nitrogen based magnetic material has a thickness of less than 10 nm.
(13) The composite magnetic material for a magnet according to any one of (5) to (12), wherein a layer composed of the ferrite based magnetic material in the composite magnetic material for a magnet is formed on a surface of the rare earth-iron-nitrogen based magnetic material by a ferrite plating method.
(14) A magnetic material-resin composite material for a magnet, comprising 5 to 99.9 mass % of a composite magnetic material for a magnet according to any one of (1) to (13) and 0.1 to 95 mass % of a resin.
(15) A method for manufacturing a ferrite-plated rare earth-iron-nitrogen based composite magnetic material for a magnet, comprising the steps of

subjecting a magnetic material of a rare earth-iron-nitrogen based magnetic material represented by the following general formula:

RₓFe_{(100-x-y)}N_{y}

(wherein R is at least one of rare earth elements containing Y; 50 atomic % or more of R is Sm; and x and y satisfy 3 atomic %<x<30 atomic % and 1 atomic %<y<30 atomic %, respectively),
to an acid treatment with an acidic aqueous solution; and successively,

dispersing the magnetic material in water without being brought into direct contact with air, further successively shifting pH of the dispersion solution from acidity to basicity with a basic aqueous solution, simultaneously adding an aqueous solution containing at least divalent iron ions thereto, mixing and stirring the dispersion solution under an atmosphere containing oxygen, and thereby carrying out a ferrite plating.

(16) A method for manufacturing the material according to any one of (1) to (14), wherein the material is at least once magnetically oriented using an external magnetic field.

### ADVANTAGES OF THE INVENTION

The present invention can provide a composite magnetic material for a magnet, which high magnetic characteristics and a high electrical resistivity, especially a composite magnetic material for a magnet, which is suitably utilized in a magnet for rotary motors functioning in a high frequency region, and in other applications.

### BRIEF DESCRIPTION OF THE DRAWINGS

FIG. 1 is an illustrative diagram interpreting an exchange-spring magnet; (a) is “a soft magnetic-hard magnetic mixed magnetic material” in which a soft magnetic phase and hard magnetic phase are not coupled by the exchange interaction; and (b) is “an exchange-spring magnet” in which a soft magnetic phase and hard magnetic phase are coupled by the exchange interaction;

FIG. 2 is a scanning electron microscope (SEM) photograph of a rare earth-iron-nitrogen based magnetic material powder and the composite magnetic material powder for a magnet according to the present invention; (A) is the rare earth-iron-nitrogen based magnetic material powder in Comparative Example 2; and (B) is the composite magnetic material powder for a magnet in Example 2;

FIG. 3 is a demagnetization curve of a powder-compacted magnet using the composite magnetic material for a magnet in Example 2 and the rare earth-iron-nitrogen based material in Comparative Example 2;

FIG. 4 is a scanning electron microscope (SEM) photograph of a cross section of an shock wave compression-molded magnet; (A) is the shock wave compression-molded magnet in Comparative Example 3 using the rare earth-iron-nitrogen based magnetic material; (B) is the shock wave compression-molded magnet in Example 3 using the composite magnetic material for a magnet according to the present invention; and in the figure of (B), light-colored portions are the rare earth-iron-nitrogen based magnetic material (main phase), and black portions are the ferrite based magnetic material (grain boundary phase) as a coating material;

FIG. 5 is a transmission electron microscope (TEM) photograph and an electron diffraction ring pattern of a cross section of the shock wave compression-molded magnet in Example 3; In the TEM photograph, the portion of (A) is the rare earth-iron-nitrogen based magnetic material (main phase), and the portion of (B) is the ferrite based magnetic material (grain boundary phase) as a coating material; the lower diagram is a photograph of an electron diffraction pattern of the (B) phase; and in the figure, white numerical values are Miller indices of Fe ferrite having a spinel structure;

FIG. 6 is recoil lines and demagnetization curves of the shock wave compression-molded magnets using the composite magnetic material for a magnet in Example 4 and the rare earth-iron-nitrogen based material in Comparative Example 4;

FIG. 7 is relationships between a maximum reverse field and a recoil magnetic permeability in the shock wave compression-molded magnets using the composite magnetic material for a magnet in Example 4 and the rare earth-iron-nitrogen based material in Comparative Example 4;

FIG. 8 is a diagram interpreting an assumption in calculation of the Bᵣ decreasing rate by the ferrite coating in the composite magnetic material for a magnet in Example 4;

FIG. 9 is a TEM photograph of the vicinity of an interface between the ferrite coating layer and the rare earth-iron-nitrogen based magnetic material in the shock wave compression-molded magnets in Example 4; in the figure, the portion of (A) is the rare earth-iron-nitrogen based magnetic material (main phase), and the portion of (B) is the ferrite based magnetic material (grain boundary phase) as a coating material; and

FIG. 10 is demagnetization curves of powder-compacted magnets using the composite magnetic material for a magnet in Example 2 and a mixed material of the rare earth-iron-nitrogen based magnetic material powder and the ferrite powder in Comparative Example 5.

### BEST MODE FOR CARRYING OUT THE INVENTION

Hereinafter, the ferrite-coated rare earth-iron-nitrogen based composite magnetic material for a magnet according to the present invention will be described in detail.

A main mode according to the present invention relates to a composite magnetic material for a magnet, obtained by coating a ferrite based magnetic material on the surface of a rare earth-iron-nitrogen based magnetic material, and the main mode is “a powder” of a composite magnetic material for a magnet in which the surface of “a powder” of a rare earth-iron-nitrogen based magnetic material is covered with a ferrite based magnetic material. After the composite magnetic material powder for a magnet is solidified and molded as it is, or a resin and the like are added thereto and molded, it is used as magnets for various types of applications. The rare earth-iron-nitrogen based magnetic material component mainly acts as the ferromagnetism of a composite magnetic material for a magnet. However, the ferrite based magnetic material component coated on the surface achieves a great improvement in the electrical resistivity, and moreover the coating component takes magnetism. Therefore, the decrease in magnetic characteristics of the whole composite magnetic material for a magnet is not so large as compared with the case where a non-magnetic coating component such as silica or magnesia is incorporated, and can be retained to be a relatively small value.

Hereinafter, there will be described the composition and the crystal structure and form of the rare earth-iron-nitrogen based magnetic material, the type and the crystal structure and form of the ferrite based magnetic material, the resin component of the magnetic material-resin composite material for a magnet, and methods for manufacturing these, particularly a method for coating the ferrite based magnetic material and a method of magnetic field orientation.

In the rare earth-iron-nitrogen based magnetic material (, which is referred to as “R—Fe—N based magnetic material” hereinafter), the rare earth element (R) needs to contain at least one element selected from the group consisting of Y, La, Ce, Pr, Nd, Pm, Sm, Eu, Gd, Tb, Dy, Ho, Er, Tm, Yb and Lu. Therefore, a mixture of two or more rare earth elements such as a misch metal or didymium may be used as a raw material, but Y, La, Ce, Pr, Nd, Sm, Gd, Dy, Er and Yb are preferable as the rare earth, and Y, Ce, Pr, Nd, Sm, Gd and Dy are more preferable. Particularly, containing 50 atomic % or more of Sm based on the total of the R component can provide a magnetic material having a greatly high magnetization and coercive force, and containing 70 atomic % or more of Sm is preferable in view of balances of oxidation-resistant performance and cost.

Rare earth elements used here may be those having a purity available from industrial production, and those in which impurities inevitably mingled in production, for example, 0, H, C, Al, Si, F, Na, Mg, Ca and Li, are present have no problem.

The rare earth-iron-nitrogen based magnetic material according to the present invention contains 3 to 30 atomic % of an R component. With the R component less than 3 atomic %, a soft magnetic metal phase containing much of an iron component is separated beyond the acceptable amount even after casting and annealing of a mother alloy, and such a type of a soft magnetic metal phase decreases mainly the coercive force and inhibits a function as a magnetic material for a high-performance magnet being one object of the present invention, which is not preferable. With the R component exceeding 30 atomic %, the magnetization decreases, which is not preferable. The more preferable compositional range of R is 5 to 15 atomic %.

Iron (Fe) is a basic composition of the rare earth-iron-nitrogen based magnetic material which acts as ferromagnetism, and is contained in 40 atomic % or more. With the content less than 40 atomic %, the magnetization is small, which is not preferable. With the content exceeding 96 atomic %, a soft magnetic metal phase containing much of Fe is separated, which is not preferable for the same reason as in the above case where an R component is insufficient. If the compositional range of an iron component is in the range of 50 to 85 atomic %, the magnetic material makes a balanced magnetic material having a high magnetization and coercive force, which is especially preferable.

The magnetic material for a magnet according to the present invention can have a composition in which 0.01 to 50 atomic % of Fe is substituted with an M component, which is at least one element selected from the group consisting of Co, Ni, B, Al, Ti, V, Cr, Mn, Cu, Zn, Ga, Zr, Nb, Mo, Pd, Ag, Cd, In, Sn, Hf, Ta, W, Ru, Re, Os, Ir, Pt, Pb, Bi, an alkali metal and an alkaline earth metal. The incorporation of an M component does not always cause all of the M component to substitute Fe and to be incorporated in the crystal structure. However, in some cases, depending on the kind of the elements, one of magnetic characteristics such as magnetization, Curie point, coercive force and squareness ratio, and the electrical resistivity rises, and the oxidation-resistant performance can be improved as well.

The magnetic characteristic used here refers to at least one of the saturation magnetization Jₛ (T), the residual magnetic flux density Bᵣ (T), the magnetic anisotropy magnetic field μ₀Hₐ (T), the magnetic anisotropy energy μ₀Eₐ (T), the magnetic anisotropy ratio Bᵣ/Jₛ (%), the intrinsic coercive force μ₀H_{cJ} (T), the maximum energy product (BH)ₘₐₓ (J/m³), the Curie point T_{c} (K), the thermal demagnetizing factor α (%) and the temperature variation rate of the intrinsic coercive force β (%), of a material. Here, the magnetic anisotropy ratio refers to a ratio (p/q) of the magnetization (p) in the hard magnetization direction to the magnetization (q) in the easy magnetization direction when an external magnetic field of 1.5 T is applied. The unit of “a magnetic field” in the present description is expressed as a unit obtained by converting a magnetic field multiplied by a vacuum magnetic permeability to T (tesla). The conversion expression of units of the magnetic fields is: 1 (T)=10⁴ (Oe)=1/(4π)×10⁷ (A/m). That is, 1 T corresponds to about 0.8 MA/m.

In the present invention, in the case where there is an expression as an “iron component” or an “Fe component”, or in the case where there is an expression as “Fe” or “iron” in the formula such as “R—Fe—N based” or the like, a composition is also included in which 0.01 to 50 atomic % of Fe is substituted with an M component. The substitution amount of Fe with an M component is preferably in the range of 1 to 50 atomic %.

With the M component exceeding 50 atomic %, not only the above-mentioned advantage relative to soaring of the manufacturing cost is small and no profit is gained in cost performance, but also the magnetic characteristics are unstable. On the other hand, with that less than 0.01 atomic %, almost no effect of the substitution is found. Above all, Co and Ni have a large effect on the oxidation-resistant performance, and in addition, Co can largely improve the Curie point, and thus these are preferable components in some cases. In that case, the substitution amount of Fe with these components is especially preferable in the range of 2 to 20 atomic %. Further, the addition of Mn and the appropriate regulation of the nitrogen content can provide a pinning type magnetic material and even the particle diameter exceeding 10 μm can make a magnetic material having a high coercive force. Such a magnetic material is disclosed, for example, in Japanese Patent No. 3560387 (hereinafter, referred to as “PATENT DOCUMENT 3”) and Nobuyoshi Imaoka, Atsushi Okamoto, Hiroaki Kato, Tetsu Ohsuna, Kenji Hiraga and Mitsuhiro Motokawa, “Magnetic Properties and Microstructure of Mn-Substituted Sm₂Fe₁₇Nₓ”, Journal of the Magnetics Society of Japan, vol. 22, No. 4-2 (1998), pp. 353-356 (in Japanese) (hereinafter, referred to as “NON-PATENT DOCUMENT 1”).

The nitrogen (N) content incorporated in the above-mentioned composition needs to be in the range of 1 to 30 atomic %. With the content exceeding 30 atomic %, the magnetization is low as a whole, and with the content less than 1 atomic %, the coercive force is not so much improved, which is not preferable. That nitrogen is contained in a magnetic material is the greatest feature of the composition according to the present invention, but one of main effects thereof is the increases in the magnetic anisotropy magnetic field, the magnetic anisotropy energy and the magnetic anisotropy ratio (these three magnetic characteristics are generically referred to as “magnetic anisotropy”), and the electrical resistivity. This feature makes a basis most suitable for a material for high-performance magnets which can reduce the eddy current loss to some degree, different from other metal based magnetic materials. In the present invention, a ferrite based magnetic material layer (this layer is referred to as “ferrite coating layer”) coated on a rare earth-iron-nitrogen based magnetic material takes on much part of the improvement of the electrical resistivity, but since even in the case where the ferrite coating layer is intended to be thinned in order to acquire a higher magnetization, the electrical resistivity of a main phase to bear high magnetic characteristics is high as long as a rare earth-iron-nitrogen based magnetic material is contained, a large versatility can be provided in the material design to exhibit the target function, which is a great advantage.

With respect to the preferable range of the nitrogen content, the optimum nitrogen content depends on the R—Fe composition ratio, the amount ratio of a sub-phase, the crystal structure and the like of a target R—Fe—N based magnetic material, so if, for example, Sm_{10.5}Fe_{76.1}Co_{12.4} having a rhombohedral structure is selected as a raw material alloy, the optimum nitrogen content is about 10 to 22 atomic %. The optimum nitrogen content at this time refers to a nitrogen content, depending on purposes, by which at least one characteristic of the oxidation-resistant performance, the magnetic characteristics and the electrical resistivity becomes optimum.

In the composition of the R—Fe—N based magnetic material according to the present invention, a rare earth component is in the range of 3 to 30 atomic %; an iron component is in the range of 40 to 96 atomic %; and N is in the range of 1 to 30 atomic %, and these ranges are simultaneously satisfied. The R—Fe—N based magnetic material obtained in the present invention may further contain 0.01 to 10 atomic % of hydrogen (H).

If H is contained in the above-mentioned composition range, the oxidation-resistant performance and the magnetization are improved. If H is present locally on the surface, it has also a function of making the coating of a ferrite phase firm. The especially preferable composition of the R—Fe—N based magnetic material according to the present invention is represented by the general formula: RₓFe_{(100-x-y)}N_{y}H_{z}(wherein 3 atomic %<x/(1−z/100)<30 atomic %; 1 atomic %<y/(1−z/100)<30 atomic %; and 0.01 atomic %<z<10 atomic %, and x, y and z are selected so that these three expressions are simultaneously satisfied).

Some manufacturing methods cause 0.1 to 20 atomic % of oxygen (O) to be contained, and improve the stability of the magnetic characteristics, and can make an R—Fe—N based magnetic material having a high electrical resistivity. Therefore, the more preferable composition of the R—Fe—N based magnetic material according to the present invention is represented by the general formula: RₓFe_{(100-x-y-z-w)}N_{y}H_{z}O_{w} (wherein 3 atom %<x/{(1−z/100)(1−w/100)}<30 atom %; 1 atom %<y/{(1−z/100)(1−w/100)}<30 atom %; 0.01 atom %<z/(1−w/100)<10 atom %; and 0.1 atom %<w<20 atom %, and x, y, z and w are selected so that the four expressions are simultaneously satisfied). If the oxygen component is present locally on a magnetic powder surface, it has a large effect on the improvement of the electrical resistivity. However, there are some cases where containing no surface-localized oxygen is more preferable, including the case where a soft magnetic phase is incorporated as a ferrite coating layer. In that case, a process of removing this portion is carried out in some cases.

In the present invention, 0.01 to 50 atomic % of a nitrogen component of the rare earth-iron-nitrogen based magnetic material may be substituted with at least one element of the group consisting of H, C, P, Si and S. The incorporation of the element, depending on the kind and amount of the element, does not always cause the N component to be substituted with all of the element, and does not always cause the substitution of one-on-one. However, depending on the kind and amount of a substituting element, the electrical and magnetic characteristics such as the oxidation-resistant performance and the coercive force are improved in some cases. Also, in a magnetic material-resin composite material for a magnet, the affinity for the resin component is made good, and the improvement in mechanical properties can be expected in some cases.

With the substitution amount less than 0.01 atomic %, almost no effect of the above-mentioned substitution is found; and with the substitution amount exceeding 50 atomic %, the effect of nitrogen on the improvement of the electrical resistivity and the optimization of the magnetic characteristics is inhibited, which is not preferable.

In the present invention, in the case where there is an expression as an “nitrogen component” or an “N component”, or in the case where there is an expression as N or nitrogen in the formula such as “R—Fe—N based” or in the context discussing magnetic material compositions, a composition is also included in which 0.01 to 50 atomic % of N is substituted with H, C, P, Si or S.

The rare earth-iron-nitrogen based magnetic material according to the present invention preferably contains a phase having rhombohedral, hexagonal and tetragonal crystal structures. In the present invention, a phase making such crystal structures and containing at least R, Fe and N is referred to as a “main phase”; and a phase having a composition not making such crystal structures or making another crystal structure is referred to as a “sub-phase”. The sub-phase is a phase, which is not a main phase, produced intentionally or unintentionally in the process of manufacture of a rare earth-iron-nitrogen(-hydrogen-oxygen) based magnetic material from a rare earth-iron raw material. A main phase contains oxygen in addition to an R component, an Fe component and an N component, in some cases. However, in the case of constituting an exchange-spring magnet, as described later, oxygen contained in the main phase is preferably suppressed to as little as possible in some cases.

Preferable examples of the crystal structure of the main phase of a rare earth-iron-nitrogen based magnetic material include nitride phases having a high magnetism of the rhombohedral crystal having the same crystal structure as Th₂Zn₁₇ and the like, the hexagonal crystal having the same crystal structure as Th₂Ni₁₇, TbCu₇, CaZn₅ and the like, and the tetragonal crystal such as an RFe₁₂₋ₓMₓN_{y} phase, and at least one thereof needs to be contained.

Above all, containing the rhombohedral crystal having the same crystal structure as Th₂Zn₁₇ and the like, and the hexagonal crystal having the same crystal structure as Th₂Ni₁₇ and the like is most preferable in order to secure good electrical and magnetic characteristics and their stability.

“Electrical and magnetic characteristics” used here refers generically to magnetic characteristics and the electrical resistivity.

An R—Fe—N based magnetic material may contain as a sub-phase an R—Fe alloy raw material phase, a hydride phase, a decomposed phase or oxidized amorphous containing an Fe nanocrystal, or the like. However, the volume fraction thereof needs to be suppressed lower than the content of the main phase in order to sufficiently exhibit the advantage of the present invention, and it is very preferable in practical use that the content of the main phase exceeds 75% by volume with respect to the total of the R—Fe—N based magnetic material.

“Volume fraction” used here refers to a volume proportion which some component occupies with respect to the total volume including voids of a magnetic material.

The main phase of an R—Fe—N based magnetic material is obtained by the interstitial nitrogen between lattices of an R—Fe alloy as a main raw material phase, and in many cases, by the expansion of the crystal lattices, but the crystal structure thereof has nearly the same symmetry as the main raw material phase.

“Main raw material phase” used here refers to a phase containing at least R and Fe, not N, and having the rhombohedral, hexagonal or tetragonal crystal structure. (A phase having a composition or a crystal structure other than those of the main raw material phase, and not containing N is referred to as “sub-raw material phase”.)

Along with the expansion of crystal lattices due to the interstitial nitrogen, one or more of the oxidation-resistant performance or the magnetic characteristics and electrical resistivity are improved, and an R—Fe—N based magnetic material which is suitable in practical use is made. It is not until after the nitrogen introduction process that a suitable high-performance magnetic material for a magnet is made, and electrical and magnetic characteristics quite different from those of a conventional R—Fe alloy which contain no nitrogen, and Fe are firstly developed thereby.

For example, in the case where Sm_{10.5}Fe_{89.5} having the rhombohedral structure is selected as a main raw material phase of an R—Fe component mother alloy, the incorporation of nitrogen increases the electrical resistivity and improves magnetic characteristics including the Curie point, magnetization and magnetic anisotropy energy, and improves the oxidation-resistant performance.

The rare earth-iron-nitrogen based magnetic material according to the present invention is a powder having an average particle diameter of 0.1 to 2,000 μm, and preferably 0.2 to 200 μm. The region less than 0.2 μm is a region where the decrease of magnetization and the aggregation of a magnetic powder become remarkable, magnetic characteristics which the rare earth-iron-nitrogen based magnetic material inherently has cannot fully be exhibited, and the region is not suited to the common industrial production. Therefore, the region cannot be said to be a very suitable particle diameter range. However, even if the average particle diameter is less than 0.2 μm, the rare earth-iron-nitrogen based magnetic material is overwhelmingly superior in the oxidation-resistant performance to the metal based magnetic material for a magnet, which does not contain nitrogen. Therefore, it is suitable for a high-performance magnetic material for a magnet of a special application of a thin thickness or a super small size. However, the average particle diameter of less than 0.1 μm causes the ignition quality, and makes the manufacturing process complicated, including the handling of a powder in a low-oxidative atmosphere. Exceeding 2,000 μm makes difficult the manufacture of a homogeneous nitride, and additionally makes a magnetic material inferior in the electrical resistivity. Therefore, the average particle diameter is generally more preferably 200 μm or less, but even in the range exceeding 200 μm and less than 2,000 μm, depending on the size of the crystal grain diameter and the easiness of nitriding of a rare earth-iron mother alloy (also depending on the kind of an M component), a magnetic material can be manufactured with no problem, and the magnetic material having a high electrical resistivity can be made. Further if the average particle diameter is 0.5 to 100 μm, a magnetic material having a high coercive force and a high electrical resistivity is made, which is especially preferable. The determination method of the particle diameter of the composite magnetic material for a magnet according to the present invention has only to add a numerical value obtained by multiplying the thickness of a ferrite coating layer by two to the average particle diameter of the above-mentioned rare earth-iron-nitrogen based magnetic material.

“Average particle diameter” used here refers to a median diameter determined from an equivalent-volume diameter distribution curve obtained by a particle diameter distribution analyzer usually used.

The shape of the rare earth-iron-nitrogen based magnetic material powder may be not only a form such as a spherical or lump form, but also a flat or slender form such as a scaly, ribbon-like, needle-like, discoidal or ellipsoidal form, or an indeterminate powder, or a mixed powder thereof. However, the form on which a ferrite based magnetic material can effectively be coated is needed.

A composite magnetic material for a magnet using the rare earth-iron-nitrogen based magnetic material according to the present invention may contain a material becoming a magnetic material for a magnet among hard magnetic ferrite based magnetic materials such as a Nd—Fe—B based magnetic material, a Sm—Co based magnetic material, an Alnico magnetic material, a Mn—Al based magnetic material, a Co ferrite, a Ba ferrite, a Sr ferrite and the like, or a mixture thereof. However, the volume fraction needs not to exceed the volume fraction of the rare earth-iron-nitrogen based magnetic material. However, this is not applied to a composite magnetic material for a magnet using a rare earth based magnetic material according to the present invention as a material contained in other than the rare earth-iron-nitrogen based magnetic material according to the present invention.

Then, a ferrite based magnetic material coated on the rare earth-iron-nitrogen based magnetic material according to the present invention will be described in detail.

The ferrite based magnetic material coated on the surface of the rare earth-iron-nitrogen based magnetic material includes oxide based magnetic materials including: ferrite based magnetic materials having a spinel structure having a main composition of (M′, Fe)₃O₄ such as Fe ferrites including magnetite, maghemite and an intermediate of magnetite and maghemite, Ni ferrite, Zn ferrite, Mn—Zn ferrite, Ni—Zn ferrite and Mg—Mn ferrite; iron garnet type ferrite materials such as Y₃Fe₅O₁₂; soft magnetic ferrite based magnetic material such as soft magnetic hexagonal magnetoplumbite type ferrite; and hard magnetic ferrite based magnetic material such as Ba ferrite and Sr ferrite.

The M′ component (as described above, a component contained in the general formula of a ferrite having a spinel structure) represents a divalent or monovalent metal element out of the R component and the M component, and is specifically Sm, Eu, Yb, Co, Ni, V, Ti, Cr, Mn, Cu, Zn, Ga, Zr, Nb, Mo, Pd, Ag, Cd, In, Sn, Hf, Ta, W, Pb, Bi, an alkali metal and an alkaline earth metal. An M component other than the M′ component is contained not only in an R—Fe—N based magnetic material, but also in a ferrite coating layer in some cases.

Among the above-mentioned ferrite based magnetic materials, as a ferrite based magnetic material coated on the rare earth-iron-nitrogen based magnetic material, a soft magnetic ferrite material is preferable because it can achieve a higher magnetization, as long as the rare earth-iron-nitrogen based magnetic material powder and the ferrite coating layer are well coupled by the exchange interaction.

On the other hand, since a ferrite having a spinel structure well holds a chemical bond with the surface of the rare earth-iron-nitrogen based magnetic material, and improves high magnetic characteristics and the oxidation-resistant performance, the ferrite is a preferable component as a ferrite coating layer. Therefore, a soft magnetic ferrite based magnetic material having a spinel structure is a very preferable component in the composite magnetic material for a magnet according to the present invention.

A composite magnetic material for a magnet having the above-mentioned composition and having a hard magnetic phase and a soft magnetic phase coupled by the exchange interaction is called an exchange-spring magnet or a nanocomposite magnet, and has the following feature. The magnet has a soft magnetic phase therein; magnetizations of the soft magnetic phase and a hard magnetic phase are mutually coupled by the exchange interaction; hence, the magnetization of the hard magnetic phase prohibits the magnetization of the soft magnetic phase from reversing by a reversed magnetic field to exhibit a characteristic as if the soft magnetic phase were not present.

In a composite material of a hard magnetic phase and a soft magnetic phase which are not coupled by the exchange interaction, when a small reversed magnetic field is applied from the outside, the magnetization of the soft magnetic phase is easily reversed; and even if the magnetic field is returned to zero, the reversed magnetization of the soft magnetic phase does not return to its original state. Therefore, the presence of a soft magnetic phase deteriorates magnet characteristics. Therefore, when a high-performance magnet material is fabricated, the soft magnetic phase is generally removed thoroughly. By contrast, in an exchange-spring magnet, since the magnetization of a soft magnetic phase is coupled with the magnetization of a hard magnetic phase by the exchange interaction, the magnetization of the soft magnetic phase is not easily reversed even if a reversed magnetic field is applied, because the magnetization of the soft magnetic phase is supported by the magnetic anisotropy of the magnetization of the hard magnetic phase. If the magnetic field is returned to zero, the magnetization of the soft magnetic phase is returned to its original state. Therefore, the presence of a soft magnetic phase does not deteriorate magnet characteristics, and for example, a rapid quenched foil or a strip cast material of Nd—Fe—B or Sm—Fe—N gives higher magnetic characteristics than hard magnetic single materials by utilizing α—Fe or Fe₃B having a higher magnetization than a hard magnetic phase as a soft magnetic phase. Here, exchange-spring magnets put in practical use are all isotropic ones (see, for example, Masato Sagawa (ed.) “Permanent Magnet—Material Science and Application”, published by Agne Gijutsu Center, (2007), p. 281 (in Japanese) (hereinafter, referred to as “NON-PATENT DOCUMENT 2”)). At present, no high-performance magnet having anisotropy has been put in practical use.

As one of general factors of the above-mentioned exchange-spring magnets, “a high residual magnetic flux density” is known (Masuo Okada, The Magnetics Society of Japan, Study Group Paper, 91, 23 (1995) (in Japanese) (hereinafter, referred to as “NON-PATENT DOCUMENT 3”)). In order to achieve this, it is essential that a soft magnetic phase has a higher magnetization than a hard magnetic phase. Therefore, an attempt in which an exchange-spring magnet is constituted by adding a ferrite of a low-magnetization soft magnetic phase (for example, the magnetization of magnetite is 0.6 T) to a rare earth-iron-nitrogen based magnetic material of a high-magnetization hard magnetic phase (for example, the magnetization of Sm₂Fe₁₇N₃ is 1.52 T) leads to decrease the residual magnetic flux density. As the result, such an attempt is hard to be considered in the practical sense in the industry concerned. As is disclosed in the present invention, a merit of exhaustive studies on a composite magnetic material for a magnet having the constitution required in the present invention has occurred only when an effect of mainly improving the electrical resistivity was expected on a soft magnetic phase. In the present invention, irrespective of the description in NON-PATENT DOCUMENT 3, a magnet having features described below and utilizing a hard magnetic-soft magnetic composite magnetic material for a magnet is called an exchange-spring magnet.

The features of the exchange-spring magnet according to the present invention, as expected from the constitution described above, are as follows. 1) A magnetization curve in a low magnetic field (between 0 to 0.5 T as a criterion, because the intrinsic coercive force does not have a value higher than the criterion value even in hard magnetic ferrites having a much higher coercive force than soft magnetic ferrites) has no inflection point, and draws a smooth locus. In spite of the presence of a soft magnetism, the magnet behaves as if it were a single magnet. 2) The recoil magnetic permeability (a magnetic permeability corresponding to a slope of a recoil line at an operation point) is higher than that of a rare earth-iron-nitrogen based magnetic material (or a rare earth based magnetic material) containing no ferrite coating layer. This behavior is called spring back, and how the exchange-spring magnet according to the present invention behaves with respect to spring back will be again described in detail when data of Example 4 and Comparative Example 4 described later are compared and described.

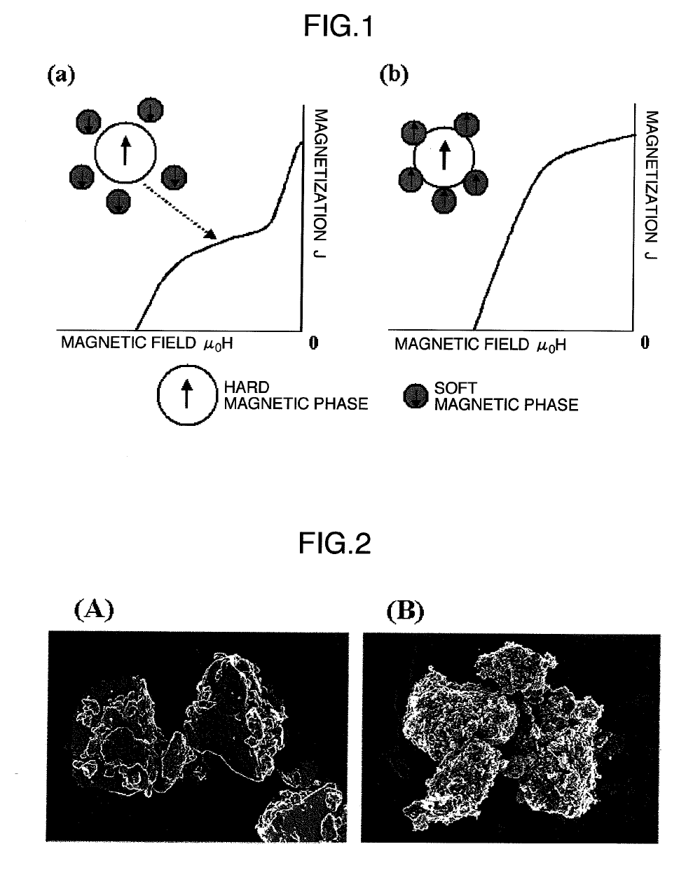

FIG. 1 shows an illustrative diagram of the situation of 1) described above. (a) is an illustrative demagnetization curve of a “soft magnetic-hard magnetic mixed magnetic material” in which a soft magnetic phase and a hard magnetic phase are not coupled by the exchange interaction, and (b) is an illustrative demagnetization curve of an “exchange-spring magnet” in which a soft magnetic phase and a hard magnetic phase are coupled by the exchange interaction. In (a), since the soft magnetic phase undergoes the magnetization reversal in a low magnetic field and reaches the saturation, there is an inflection point on the magnetization curve, and consequently the magnetic material is inferior in the coercive force, squareness ratio and maximum energy product. On the other hand, in (b), since the reversal of the magnetization of the soft magnetic phase in a low magnetic field is held back by the magnetization of the hard magnetic phase through the exchange interaction, a smooth magnetization curve having no inflection point is obtained. As described above, in the case of a magnetic material for a magnet in which a soft magnetic phase is present, whether or not a demagnetization curve in a low-magnetic field region (defined as a 0 to 0.5 T region) has an inflection point can be considered as one index of whether or not an exchange-spring magnet is made.

In the composite magnetic material for a magnet according to the present invention, since a rare earth-iron-nitrogen based magnetic material powder of a hard magnetic phase (hereinafter, the main phase of this “rare earth-iron-nitrogen based magnetic material of a hard magnetic phase” is referred to as an R phase) and a ferrite coating layer of a soft magnetic phase (hereinafter, this “ferrite coating layer of a soft magnetic phase” is referred to as an F phase) are mutually well coupled by the exchange interaction, the exchange-spring magnet according to the present invention can be made in the case where the ferrite coating layer is a soft magnetic material.

A magnetic material having a soft magnetic phase, especially a cubic crystal structure having a spinel structure, holds stronger chemical bond with the R phase and exhibit a stronger coupling by the exchange interaction than the case where the ferrite coating layer is a hard magnetic phase. This feature, for example, when a composite magnetic material for a magnet is applied to a light-weight magnet having many voids even in bond magnet materials and solid materials for bulk magnets, is effective in order to improve the oxidation-resistant performance of the composite magnetic material for a magnet. However, in the case where an Zn ferrite is an F phase, since the magnetization of itself is too low to improve so much the magnetization of a composite magnetic material for a magnet, and additionally the chemical bond with a rare earth-iron-nitrogen based magnetic material is insufficient in some cases, the advantage of the present invention, “to raise the electrical resistivity without a large reduction of magnetic characteristics”, cannot be exhibited in some cases.

Here, the fundamental aims of the present invention are again stated as follows.

In order to raise the electrical resistivity of a metal based magnet, it suffices if a ceramic or resin such as an insulative or a high-electrical resistivity oxide is steadily incorporated between grains constituting the magnet. However, if the incorporated material is a non-magnetic one, since the magnetization decreases corresponding to the incorporated volume fraction, a high-performance magnet cannot be obtained. In order to satisfy these two contrary phenomena, it is needed that an oxide phase having a high electrical resistivity and a magnetism is incorporated between hard magnetic grains so that a magnetism does not drop largely and the property of “electrical insulation” is held. Further if the “magnetic coupling” for coupling by the exchange interaction is secured by sufficiently chemically bonding the hard magnetic grain phase and a soft magnetic grain boundary phase, the magnetic performance does not decrease largely even if an easily coatable ferrite soft magnetic phase is incorporated. Such a methodology is called “electrical insulation and magnetic coupling” by the present inventors. It is the achievement of the “electrical insulation and magnetic coupling” that connects directly to the solution of the problems of the present invention.

A ferrite-coated R—Fe—N based magnetic material in the present invention is preferably an exchange-spring magnet as described heretofore in order to achieve high magnetic characteristics and electrical resistivity.

To obtain the exchange-spring magnet according to the present invention, as described in K. Kobayashi, Y. Iriyama and T. Yamaguchi, J. Alloys and Compounds, 193, 235 (1993) (hereinafter, referred to as NON-PATENT DOCUMENT 4), for example, an amorphous-like surface oxide layer of about 10 nm is observed on the micropowder surface of Sm₂Fe₁₇N₃, but it is important to remove the oxide layer present on the main phase surface as much as possible. The thickness is preferably less than 10 nm, more preferably less than 5 nm, and still more preferably less than 2 nm. The above will be clarified in comparison of Example 2 with Comparative Example 5, or Example 8. In Example 4, it will be stated using the calculation of the decreasing rate of the residual magnetic flux density before and after a ferrite plating, that an excellent exchange-spring magnet performance was brought out by removing the above-mentioned surface oxide layer by an optimum ferrite coating operation (an operation in which a surface oxide layer of a rare earth-iron-nitrogen based magnetic powder is removed by an acid treatment of a pre-process of a ferrite plating process in a “ferrite coating treatment” described later) and instead replacing the surface oxide layer by a ferrite coating phase. Further in Example 4, TEM observation will confirm the removal of the surface oxide layer by the acid treatment of a pre-process of the ferrite plating step.

An oxide layer on a rare earth-iron-nitrogen based magnetic material surface and an oxide layer of an R phase which is sometimes present in the R phase-F phase interface of a ferrite-coated rare earth-iron-nitrogen based composite magnetic material for a magnet can be identified by the transmission electron microscope (TEM). The discrimination can be done by: 1) whether much of a rare earth is present in the phase; and 2) whether the phase is amorphous, but can be made sure by a combination of methods such as EDX and electron beam diffraction.

In the ferrite coating layer, a ferrite based magnetic material exemplified above may be mixed with a perovskite type magnetic material such as LaFeO₃, a rutile type magnetic material such as CrO₂, colundum or an ilumenite type magnetic material, manganite and chromite having magnetism, or an oxide based magnetic material such as V or Co, and may contain a rare earth oxide, a rare earth-iron oxide, or a sub-phase or a by-product of an oxy oxide such as hematite or goethite, but the volume fraction thereof needs not to exceed the volume fraction of the ferrite based magnetic material.

The preferable compositional range represented by the general formula R_{α}Fe_{(100-α-β-γ)}N_{β}O_{γ} of a composite magnetic material for a magnet in which the ferrite based magnetic material is coated on the surface of the rare earth-iron-nitrogen based magnetic material according to the present invention is: 0.3 atomic %<α<30 atomic %; 0.1 atomic %<β<30 atomic %; and 0.1 atomic %<γ<75 atomic %, and α, β and γ are selected so that these three expressions are simultaneously satisfied. With the oxygen content less than 0.1 atomic %, the thickness of the ferrite coating layer is not sufficient and the electrical resistivity is not sufficiently improved, which is not preferable; and with that exceeding 75 atomic %, a composite magnetic material for a magnet having high magnetic characteristics is not made, which is not preferable. The more preferable range is: 0.5 atomic %<α<30 atomic %; 0.2 atomic %<<30 atomic %; and 0.2 atomic %<γ<50 atomic %, and this range makes a material having balanced magnetic characteristics and electrical resistivity. 0.01 to 50 atomic % of Fe may be substituted with an M component.

In the present invention, the thickness of the ferrite coating layer needs to be 0.8 to 10,000 nm. With the thickness less than 0.8 nm, the electrical resistivity of a composite material is hardly raised, and magnetic properties of the ferrite coating layer cannot sufficiently be exhibited, which is not preferable. With that exceeding 10,000 nm, even if the electrical insulation can sufficiently be secured, since the ferrite coating layer has a lower magnetization than an R—Fe—N based magnetic material in many cases, the magnetization of a composite magnetic material for a magnet decreases, not making a high-performance magnet.

Further, the preferable thickness range of a ferrite coating layer is as follows. The thickness range is not such that the ferrite coating layer is too thin for the superparamagnetic property to be dominant and by contrast, the ferrite coating layer is too thick for an influence of the anisotropy originated from the magnetization of a hard magnetic phase by the exchange interaction to be dilute, that is, in the range of 2 to 1,000 nm. In either range of less than 2 nm and exceeding 1,000 nm, the coercive force is reduced.

The crystal grain diameter of a ferrite phase in the coating layer according to the present invention is preferably 0.8 to 100 nm. With the diameter less than 0.8 nm, the electrical resistance of the composite magnetic material for a magnet hardly becomes large; and with that exceeding 100 nm, the coercive force decreases largely. The preferable range of the crystal grain diameter of the ferrite phase is 2 to 50 nm.

Thus, for a composite magnetic material for a magnet in order to have a high electrical resistivity and a strong bond of the R phase and the F phase by the exchange interaction, although the grain diameter of the R—Fe—N based magnetic material is suppressed to a lower one to advantageously make the specific surface area larger, if the average grain diameter is too small, the magnetization decreases and a high-performance magnet may possibly not be made. That is, the balance between the average grain diameter (r) of the R—Fe—N based magnetic material and the thickness (d) of the ferrite coating layer is important, and the diameter and the thickness are desirably selected in the range of 0.00001≦d/r≦10 depending on various types of applications.

The thickness of a ferrite coating layer can be determined as a value of approximately 1 significant figure by the observation of the cross section of a composite magnetic material for a magnet using a scanning electron microscope (SEM) or a transmission electron microscope (TEM). In the case where the composite magnetic material for a magnet according to the present invention is a powder, and the thickness of the ferrite coating layer is 10 nm or more, the thickness can be confirmed by determining the average particle diameters before and after ferrite coating by the method described before and obtaining a value half the difference therebetween. Although the thickness of the ferrite coating layer according to the present invention refers to its average value, even if the surface coating ratio deviates largely from 100% and falls below 90%, an average value on the assumption that the surface coating ratio is 100% is determined. That is, with respect to the value of the thickness of the ferrite coating layer in this case, a more exact value can be obtained by calculating and determining the value from the volume fraction of the ferrite coating layer relative to the whole and the specific surface area of the rare earth-iron-nitrogen based magnetic material. Of course, even if the surface coating ratio is 100%, this method can be applied, and if the accuracy of physical quantities used in the calculation is high, the thickness of the ferrite coating layer can be known by a value of 2 or more significant figures in some cases.

In the case where the composite magnetic material for a magnet according to the present invention is molded and the ferrite coating layer makes a continuous phase, a value half the average thickness of the continuous phase is the thickness of the ferrite coating layer, but it is usually the simplest method that observes the cross section of a molded product of the composite magnetic material for a magnet, obtains the volume fractions of the ferrite grain boundary layer and the rare earth-iron-nitrogen based magnetic material main phase, and calculating the thickness from the fraction values and the particle diameter or the specific surface area of the rare earth-iron-nitrogen based magnetic material.

Then, a method for identifying a ferrite coating layer of a composite magnetic material for a magnet in the present invention will be described.

In the case where the thickness of the ferrite coating layer is sufficiently large, the identification using the common X-ray diffractometry is possible. However, in the region where d/r is 0.1 or less and d is below 200 nm, since the crystallinity of the rare earth-iron-nitrogen based magnetic material is high and the symmetry of the crystal is low in many cases, many diffraction peaks having a high intensity emerge in a diffraction pattern of the composite magnetic material for a magnet. In this case, the diffraction peaks of the ferrite coating layer are concealed and the identification by the X-ray diffractometry is very difficult in some cases. Stated reversely, for the identification of the rare earth-iron-nitrogen based magnetic material, use of the x-ray diffractometry is suitable.

Under the situation described above, a method of the identification is effective in which a composite magnetic material for a magnet is made thin and only the ferrite coating layer is subjected to the electron beam diffractometry and the energy dispersive X-ray analysis (EDX). The electron beam can conduct a high-precision analysis if the electron beam diameter is equal or smaller than the thickness of the ferrite coating layer or if the electron beam diameter does not exceed 10 times the thickness even if exceeding the thickness.

As an example, in the case where the thickness of a ferrite coating layer is about 100 nm, preferable is the following condition: a camera length of 0.2 m; an acceleration voltage of 200 kV; an electron beam wavelength of 0.00251 nm; and an electron beam diameter of 50 nm.

The surface coating ratio is controlled in the range of 50% to 100%. With the ratio less than 50%, the electrical conduction is caused by transfer through between grains, and does not contribute to the rise of the electrical resistivity. Further, the eddy current is caused across between grains, resulting in a poor effect of reducing loss.

The surface coating ratio is preferably 80% or more, and more preferably 90% or more. In the case of applying the composite magnetic material for a magnet according to the present invention to a bond magnet and a light-weight magnet having a high porosity, the surface coating ratio is still more preferably 95% or more. The ideal coating state is a coating ratio of 100%. The surface coating ratio can be quantitatively determined using an electron beam microanalyzer (EPMA).

Then, the magnetic material-resin composite material for a magnet according to the present invention will be described.

The usable resin component of the magnetic material-resin composite material for a magnet is exemplified as follows.

Polyamide resins such as 12-nylon, 6-nylon, 6,6-nylon, 4,6-nylon, 6,12-nylon, amorphous polyamide and semi-aromatic polyamide.

Polyolefin resins such as polyethylene, polypropylene and chlorinated polyethylene.

Polyvinyl resins such as polyvinyl chloride, polyvinyl acetate, polyvinylidene chloride, polyvinyl alcohol and ethylene-vinyl acetate copolymer.

Acrylic resins such as ethylene-ethyl acrylate copolymer and polymethyl methacrylate.

Acrylonitrile resins such as polyacrylonitrile, acrylonitrile/butadiene/styrene copolymer.

Various types of polyurethane resins.

Fluororesins such as polytetrafluoroethylene.

Synthetic resins referred to as engineering plastics such as polyacetal, polycarbonate, polyimide, polysulfone, polybutylene terephthalate, polyarylate, polyphenylene oxide, polyether sulfone, polyphenyl sulfide, polyamidoimide, polyoxybenzylene and polyether ketone.

Thermoplastic resins including liquid crystal resins such as wholly aromatic polyester.

Conductive polymers such as polyacethylene.

Thermosetting resins such as epoxy resins, phenol resins, epoxy-modified polyester resins, silicone resins and thermosetting acrylic resins.

Elastomers such as nitrile rubber, butadiene-styrene rubber, butyl rubber, nitrile rubber, urethane rubber, acrylic rubber and polyamide elastomer.

The resin component of the magnetic material-resin based composite material is not limited to the resins exemplified above, but if the resin component contains at least one of the resins exemplified above, a magnetic material-resin composite material having high electrical resistivity and excellent impact resistance and moldability can be made. The content of a resin component is preferably in the range of 0.1 to 95% by mass. With the content of the resin component of less than 0.1% by mass, the effect of the resin such as the impact resistance is hardly exhibited; and with that exceeding 95% by mass, the magnetization and the maximum energy product extremely drop and the utility as a magnetic material for a magnet is poor, which is not preferable. In the applications requiring especially high magnetic characteristics and impact resistance, the content is preferably in the range of 1 to 90% by mass for the similar reason.

Although the feature of the present invention is particularly that the magnetic characteristics and the electrical resistivity are simultaneously high, if much of a resin component is formulated, the magnetic characteristics decrease even though the electrical resistivity is raised. If only the effect is considered, it is more preferable that the resin component is suppressed to less than 10 mass %. However, even if a resin component is added in the range of less than 3 mass %, for the reason that the electrical resistivity is not so much improved and by contrast, the magnetic characteristics are improved, there is a remarkable advantage in use of the composite magnetic material for a magnet according to the present invention for a magnetic material-resin composite material.

Taking the improvement of the oxidation-resistant performance into consideration, even if a resin component coexists, since there are caused the deterioration due to the reaction of a binder and a rare earth-iron-nitrogen based powder, and the deterioration of the rare earth-iron-nitrogen based magnetic material due to the diffusion of oxygen, the coating of a ferrite based magnetic material is effective in the entire range of 0.1 to 95 mass % being the content of the resin component.

In the magnetic material-resin composite material according to the present invention, the content of a magnetic material component is preferably 5 to 99.9 mass %, and more preferably 10 to 99 mass %. With the content of the magnetic material component of less than 5 mass %, the magnetization extremely drops and the utility as a magnetic material for a magnet is poor; and with that exceeding 99.9 mass %, the effect of the resin such as impact resistance is hardly exhibited, which is not preferable.

A titanium or silicon based coupling agent can be added to the magnetic material-resin composite material according to the present invention. Addition of much of a titanium based coupling agent generally improves flowability and moldability; the formulation amount of a magnetic powder can consequently be increased; and when magnetically oriented, the orientation is improved and a magnetic material-resin composite material excellent in magnetic characteristics is made.

On the other hand, use of a silicon based coupling agent has an effect of increasing mechanical strength, but generally deteriorates flowability. Both the agents may be added in order to make the best use of merits of the both. In addition to a titanium or silicon based coupling agent, an aluminum, zirconium, chromium or iron based coupling agent may be added.

Further to the magnetic material-resin composite material according to the present invention, various types of lubricants, heat resistive antiaging agents and antioxidants may be blended.

Then, methods for manufacturing the composite magnetic material for a magnet and the magnetic material-resin composite material for a magnet according to the present invention will be described, but methods thereof are not especially limited thereto.

In the present invention, an alloy composed substantially of an R component and an Fe component refers to an alloy containing an R component and an Fe component as main components, or the alloy in which Fe of the Fe component may be substituted with an M component, and the alloy which can be made into a composite magnetic material for a magnet coated by a ferrite based magnetic material by treating the alloy with ammonia gas or nitrogen gas, and as required, subjecting the treated alloy to fine pulverization and the like to obtain the rare earth-iron-nitrogen based magnetic material according to the present invention, and subjecting the magnetic material to the ferrite coating process. Further, the feature of the manufacturing method according to the present invention lies in a point that “a ferrite plating method” can be used. In the case where a rare earth-iron-nitrogen based magnetic material is a magnetically anisotropic material, since the composite magnetic material for a magnet coated on the surface thereof with a ferrite based magnetic material also becomes a magnetically anisotropic material, if “the composite magnetic material for a magnet is magnetically oriented at least once using an external magnetic field” mainly during molding, the composite magnetic material for a magnet fabricated by the ferrite plating method can make a high-performance magnet, which is especially effective.

### (1) The Preparation of a Mother Alloy

A usable manufacturing method of an R—Fe alloy is any of methods including: (i) a high frequency melting method in which metal components of R and Fe components are melted by a high frequency wave and cast in a mold or the like; (ii) an arc melting method in which metal components are charged in a boat made of copper or the like and melted by arc discharge; (iii) a drop cast method in which an arc-molten metal is dropped at a stroke in a water-cooled mold to quench the molten metal; (iv) a rapid quenching method in which a high frequency-molten metal is dropped on a rotating copper roll to obtain a ribbon-shape alloy; (v) a gas atomization method in which a high frequency-molten metal is atomized by a gas to obtain an alloy powder; (vi) an R/D method in which while a powder of an Fe component and/or an M component, or an Fe-M alloy powder, an oxide powder of the R component and/or the M component, and a reducing agent are allowed to react at a high temperature to reduce the R or the R and M components, the R or the R and M components are diffused in the Fe component and/or the Fe-M alloy powder; (vii) a mechanical alloying method in which an elemental substance of each metal component and/or an alloy is micropulverized by a ball mill or the like, they are reacted; and (viii) an HDDR (Hydrogenation Decomposition Desorption Recombination) method in which an alloy obtained by one of the methods described above is heated in a hydrogen atmosphere to once decompose the alloy to hydrides of the R and/or M, and the Fe component and/or the M component or the Fe-M alloy, and thereafter recombined to be alloyed while hydrogen is purged at a high temperature and a low pressure.

In the case of using a high frequency wave melting method or an arc melting method, when an alloy is solidified from the melting state, a sub-raw material phase composed mainly of Fe is liable to deposit, and remains especially after the nitriding process and causes a decrease in the coercive force. Hence, in order to eliminate the sub-raw material phase composed mainly of Fe and increase a main phase having a rhombohedral, hexagonal or tetragonal crystal structure, it is effective that the alloy is annealed in a gas containing at least one of inert gases such as argon and helium, and hydrogen gas, or in vacuum in the temperature range of 200 to 1,300° C., preferably in the range of 600 to 1,185° C. The alloy fabricated by this method has a larger grain diameter, a better crystallinity and a higher magnetization than the case of using the rapid quenching method or the like. Therefore, this alloy contains a large amount of the homogeneous main raw material phase, and is preferable as a mother alloy to provide the magnetic material according to the present invention.

### (2) The Coarse Pulverization and the Classification

Although the alloy ingot manufactured by the method as mentioned above, or the alloy powder by the R/D method or the HDDR method can be nitrided directly, since if the crystal grain diameter is larger than 2,000 μm, the nitriding time is prolonged, the nitriding after coarse pulverization is more efficient. The coarse pulverization to 200 μm or less is especially preferable because the nitriding efficiency is more improved.

The coarse pulverization is carried out using a jaw crusher, a hammer, a stamp mill, a rotor mill, a pin mill, a coffee mill or the like. Also use of a crusher such as a ball mill or a jet mill can prepare an alloy powder suitable for nitriding depending on conditions. A method in which after a mother alloy is made to occlude hydrogen, the pulverization is carried out by the above-mentioned crusher, or a method in which the occlusion and release of hydrogen is repeated to pulverize the alloy, may be used.

Further after the coarse pulverization, the particle size regulation using a sieve, a vibration or acoustic classifier, or a cyclone is effective in order to carrying out a more homogeneous nitriding. After the coarse pulverization and the classification, annealing in an inert gas or in hydrogen is effective because defects in the structure can be removed in some cases. Heretofore, the preparation method of a powder raw material or an ingot raw material of a rare earth-iron alloy in the manufacturing method according to the present invention has been exemplified, but there is found differences in an optimum condition of the nitriding described below depending on the crystal grain diameter, pulverizing grain diameter, surface condition and the like of these raw materials.

### (3) The Nitriding and the Annealing

The nitriding is a process of bringing a gas containing a nitrogen source such as ammonia gas and nitrogen gas into contact with the R—Fe component alloy powder or the ingot obtained in (1) or both (1) and (2) described above to incorporate nitrogen into the crystal structure.

At this time, making hydrogen coexist in the nitriding atmosphere gas is preferable in that a high nitriding efficiency is given and the nitriding can be carried out with the crystal structure being stable. In order to control the reaction, an inert gas such as argon, helium or neon is made to coexist in some cases. The most preferable nitriding atmosphere is a mixed gas of ammonia and hydrogen; particularly if the ammonia partial pressure is controlled in the range of 0.1 to 0.7, a high nitriding efficiency is given and moreover, magnetic materials over the whole range of the nitrogen content according to the present invention can be fabricated.

The nitriding reaction can be controlled by the gas composition, heating temperature, heating time and pressurizing force. Among these, the heating temperature depends on the mother alloy composition and the nitriding atmosphere, but is selected preferably in the range of 200 to 650° C. With the temperature less than 200° C., the nitriding does not progress; and with that exceeding 650° C., the main raw material phase decomposes and the nitriding cannot be carried out with the rhombohedral, hexagonal or tetragonal crystal structure held. In order to raise the nitriding efficiency and the content of the main phase, the more preferable temperature range is 250 to 600° C.

After the nitriding, annealing in an inert gas and/or hydrogen gas is preferable in view of improving magnetic characteristics. A nitriding and annealing apparatus includes a horizontal or vertical tubular furnace, a rotary reaction furnace and a closed reaction furnace or the like. The magnetic material according to the present invention can be prepared by any of the apparatuses, but particularly in order to obtain a powder having a uniform nitrogen composition distribution, use of a rotary reaction furnace is preferable.

A gas used in the reaction is supplied by a gas flow system in which a gas flow of 1 atm or higher is supplied to a reaction furnace with the gas composition kept constant, an enclosing system in which a gas is enclosed in a vessel at a pressuring force in the range of 0.01 to 70 atm, or a combination system thereof.

### (4) The Fine Pulverization

The fine pulverization is a process for pulverizing the R—Fe—N based magnetic material and R—Fe—N-H based magnetic material to a finer micropowder than these, or a process carried out in order to introduce an O component and a H component into the R—Fe—N based magnetic material to obtain a R—Fe—N—H—O based magnetic material.

A usable method of fine pulverization includes, in addition to the method cited in “(2) the coarse pulverization and the classification”, wet or dry type microcrushers such as a rotary ball mill, vibration ball mill, planetary ball mill, wet mill, jet mill, cutter mill, pin mill and automatic mortar, and a combination thereof. A method for regulating the incorporation amount of an O component and a H component in the range according to the present invention when the O component and the H component are incorporated includes a method in which the moisture content and the oxygen concentration in the fine pulverization atmosphere are controlled.

For example, in the case of using a dry type crusher such as a jet mill, the moisture content and the oxygen concentration in a pulverization gas are kept at predetermined concentrations in the ranges of 1 ppm to 1% and 0.01 to 5%, respectively; and in the case of using a wet type crusher such as a ball mill, the moisture content and the dissolve oxygen content in a pulverization solvent such as ethanol are controlled in appropriate ranges including being regulated in the ranges of 0.1 mass ppm to 80 mass % and 0.1 to 10 mass ppm, respectively.

The oxygen content can be controlled by carrying out the handling operation of fine pulverized powders in a glove box or a vessel whose oxygen partial pressure is variously controlled, or adding an operation of leaving the powders therein for a predetermined time. Since the magnetic material according to the present invention is more stable even when made into fine powders and more excellent in pulverizability than metal based magnetic materials, which are non-nitrides, even if the particle diameter after the nitriding exceeds, for example, 2,000 μm, the powders can be regulated to 0.1 to 2,000 μm by the above-mentioned fine pulverization method; however, in the case where the industrial cost merit is emphasized, it is important that the particle diameter is regulated in the range of 0.2 μm or more. After this, subjecting the powder surface to the modification by a surface modifying machine such as a hammer mill, and to various types of surface treatments such as acid treatment, alkali treatment, cleaning treatment or degrease treatment optionally makes more effective the surface coating treatment with a ferrite based material as a post-process, and is effective finally for the electrical insulation and magnetic coupling between powders and the oxidation-resistant performance.

### (5) The Ferrite Coating Treatment

A method for coating a ferrite based magnetic material on the surface of the rare earth-iron-nitrogen based magnetic material obtained until (3) or (4) described above, particularly a “ferrite plating method” effective for coating an F phase and further a ferrite having a spinel structure, will be described in detail.

An usable incorporation method of a ferrite coating layer includes a mixing method, a vapor deposition method, a sputtering method, a pulse laser deposition method, a plasma flashing method, an electrolytic or electroless plating method including a ferrite plating method, a method in which a layer of a ferrite based magnetic material powder is formed on the surface of an R—Fe—N based magnetic material powder using a surface modifying machine such as a hammer mill, and further a plasma jet method but depending on conditions.

A method for manufacturing a material which can be made of a high performance by the magnetic orientation, which is one of features of the present invention, includes a ferrite surface coating method of a rare earth-iron-nitrogen based magnetic material using a ferrite based plating method. In the case where the ferrite based magnetic material which is a coating layer according to the present invention is an F phase, the ferrite based magnetic material is preferably bonded and coated on the surface of the rare earth-iron-nitrogen based magnetic material powder by the ferrite plating method.

The ferrite plating method, since an F phase and an R phase are chemically firmly bonded, has not only an effect of providing a magnetic coupling, but also an effect of improving the oxidation-resistant performance of the R phase by the oxide coating such as ferrite stable in air. With respect to the ferrite plating method, well-known methods can be utilized, and disclosed, for example, in Masanori Abe, Journal of the Magnetics Society of Japan, vol. 22, No. 9 (1998), p. 1225 (in Japanese) (hereinafter, referred to as “NON-PATENT DOCUMENT 5”), and Republication WO 2003/015109 (hereinafter, referred to as “PATENT DOCUMENT 4”).

“The ferrite plating method” was found by Abe et al. of the present inventors, and is applied not only to powder surface plating but also to thin films, and the reaction mechanism and the like are disclosed in NON-PATENT DOCUMENT 5, but in the present invention, “the ferrite plating method” is defined as “a method in which a reaction is carried out in an aqueous solution at 100° C. or lower to directly form a ferromagnetic crystalline ferrite magnetic material on a powder surface” (the temperature condition and the basis of the in-water reaction field should be referred to line 16 on the left column of NON-PATENT DOCUMENT 5).

Hereinafter, a method for coating an R—Fe—N based magnetic material with a ferrite based magnetic material having a spinel structure will be exemplified.

The surface of the R—Fe—N based magnetic material is subjected to an acid treatment with an acidic surface treatment liquid to remove a surface oxide film, and thereafter, the magnetic material is successively dispersed in water with no direct contact with air; and then while the dispersion liquid is ultrasonic-excited, or mechanically stirred at a suitable strength or frequency, at room temperature in air, a pH adjustment liquid is dropped with a reaction liquid in the dispersion liquid to gradually shift the pH of the solution from an acidic region to an alkaline region to coat a ferrite on the surface of the R—Fe—N based magnetic material. This method is cited as one of inexpensive methods because the process is simple. The ferrite plating method according to the present invention of course is not limited to the above, but since the surface treating liquid, the reaction liquid and the pH adjustment liquid are essential components for ferrite plating, description will be added hereinafter according to the process described above.

Surface treating liquids usable are preferably acidic solutions and are inorganic acids such as hydrochloric acid, nitric acid, sulfuric acid and phosphoric acid, and additionally metal salts such as an iron chloride solution and a nickel chloride solution, aqueous solutions of double salts and complex salts thereof, organic acid aqueous solutions, and combinations thereof. Since if the pH is less than 0, the R—Fe—N based magnetic material rapidly dissolves in some cases, the pH is desirably controlled between 0 or more and less than 7. In order to mildly carry out the surface treatment and hold back an unnecessary elution of the R—Fe—N based magnetic material to the minimum, the especially preferable pH range is 2 or more and less than 7.

By this surface treatment operation, a surface oxide layer of the R—Fe—N based magnetic material powder is removed, enabling direct bonding with a ferrite phase; thus, the surface treatment operation is an important one to constitute the excellent exchange-spring magnet according to the present invention.

Then, as a solvent as a reaction field, an organic solvent or the like can be used, but water needs to be contained so that an inorganic salt can ionize.

Reaction liquids usable are solutions containing water as a main component, including chlorides such as iron chloride, nickel chloride and manganese chloride, nitrates such as iron nitrate, nitrites, sulfates, phosphates, inorganic salts of M′ components and the like, or in some cases, solutions containing water as a main component, including organic acid salts. The reaction liquid may be a combination thereof. It is essential that the reaction liquid contain iron ions. With respect to iron ions in the reaction liquid, either of the cases suffices where only divalent iron ions (Fe²⁺) are contained, where iron ions are a mixture of trivalent iron ions (Fe³⁺) and divalent iron ions (Fe²⁺), and where only trivalent iron ions are contained, but in the case of Fe³⁺ ions only, divalent or less-valent metal ions of an M′ component element needs to be contained.

pH adjustment liquids include alkaline solutions such as sodium hydroxide, potassium hydroxide, sodium carbonate, sodium hydrogencarbonate and ammonium hydroxide, acidic solutions such as hydrochloric acid, and combinations thereof. Use of a pH buffer solution such as an acetic acid-sodium acetate mixed solution, and the addition of a chelate compound and the like are possible.

An oxidizing agent is generally not essential, but is essential in the case where the reaction liquid contains Fe²⁺ ions only. Examples thereof include nitrites, nitrates, a hydrogen peroxide solution, chlorates, perchlorates, hypochlorites, bromates, organic peroxides, dissolved oxygen water and combinations thereof. It is effective that the reaction is controlled by holding a situation in which dissolved oxygen having a function as an oxidizing agent is supplied continuously to the ferrite plating reaction field by stirring in air or in the atmosphere where the oxygen concentration is controlled. Conversely, by introducing an inert gas such as nitrogen gas or argon gas continuously or temporarily by bubbling the reaction field or by other means to restrict the oxidation action of oxygen, the reaction can also be stably controlled without inhibiting the effect of the other oxidizing agent.

In a typical ferrite plating method, formation of a ferrite coating layer progresses by the following reaction mechanism. The reaction liquid contains Fe²⁺ ions, which are adsorbed to OH groups of the powder surface, thereby releasing H⁺. Then, when the oxidation reaction is carried out by oxygen in air, an oxidizing agent, an anodic current (e⁺) or the like, part of the adsorbed Fe²⁺ ions are oxidized to Fe³⁺ ions. While Fe²⁺ ions, or Fe²⁺ ions and M′²⁺ ions in the liquid are being again adsorbed on already adsorbed metal ions, accompanied by the hydrolysis, a ferrite phase having a spinel structure is produced while H⁺ is being released. Since OH groups are present on the surface of the ferrite layer, metal ions are again adsorbed; and the similar process is repeated to grow a ferrite coating layer.

In the reaction mechanism, in order to change directly from Fe²⁺ ions to a ferrite of a spinel structure, for example, magnetite, the reaction system needs to be slowly shifted from a stable region for Fe²⁺ ions to a region where magnetite is deposited by regulating pH and the redox potential so as to cross a line dividing Fe²⁺ ions and magnetite by an equilibrium curve in the pH-potential diagram of Fe. In the case where ions of M′ component elements such as M′²⁺ ions are contained, the same discussion can be made using a pH-potential diagram corresponding to the composition and the temperature, or by a prediction. Therefore, the functions of a pH adjustment agent and an oxidizing agent are very important; kinds, concentrations and adding methods thereof have large influences on the result of the reaction of whether an F phase is produced, and the purity of the ferrite coating layer.

Other factors deciding the reaction include the dispersion state and the reaction temperature of an R—Fe—N based magnetic material.

In order to smoothly perform the surface reaction of an R—Fe—N based magnetic material, or to prevent the aggregation thereof, dispersion of the R—Fe—N based magnetic material into a solution is very important, but one of well-known methods or a combination thereof are used depending on the target reaction control, the methods including a method of simultaneously using ultrasonic dispersion and a reaction excitation, a method of transporting and circulating a dispersion liquid by a pump, and a method of simply stirring by a stirring blade or a rotary drum or swinging or vibrating by an actuator or the like.

For the control of the reaction, the temperature is important. The reaction temperature to strengthen the chemical bond of an R phase and an F phase can generally be selected from a temperature of 650° C. or lower in the range where the R—Fe—N based magnetic material does not decompose, but since the ferrite plating method is a reaction in the coexistence with water, the temperature is preferably between 0 and 100° C., which is from the freezing point to the boiling point of water under the atmospheric pressure. Particularly, conceivable are applications, for example, in which an R—Fe—N based magnetic material is subjected to ferrite plating in the coexistence with a biological substance, making the best use of the advantage of the method by which the reaction proceeds sufficiently even nearly at room temperature.

In the present invention, a method in which a whole system is placed under a high pressure and plating is carried out in the temperature range exceeding 100° C., for example, the supercritical reaction, does not belong to the ferrite plating method, but if the ferrite coating layer exhibiting the effect of the present invention is formed on the surface of the rare earth-iron-nitrogen based magnetic material, it does of course belong to the composite magnetic material for a magnet according to the present invention.

As a reaction excitation method, other than temperature and ultrasonic wave as described above, pressure and optical excitation are effective in some cases.

Further, in the present invention, in the case where an aqueous solution containing Fe²⁺ is used as a reaction solution and the ferrite plating method is applied, especially in the case where a ferrite coating layer is magnetite or an intermediate of magnetite and maghemite, or even if the ferrite coating layer is other than an Fe ferrite, the reaction is carried out under the condition that Fe is mixed as divalent ions in the ferrite coating layer, it is important that divalent ions of Fe are observed in a finally produced ferrite coating layer of the composite magnetic material for a magnet according to the present invention. The amount is preferably 0.05 or more and 0.5 or less in Fe²⁺/Fe³⁺ ratio. As a method for identifying this, an electron probe microanalyzer (EPMA) is effectively used. An R—Fe—N based magnetic material and the surface of a composite magnetic material for a magnet coated by a ferrite based magnetic material are analyzed by EPMA to obtain X-ray spectra of FeL_{α}-FeL_{β}; the difference between the above two materials is taken; and the amount of Fe²⁺ ions in the surface coating ferrite phase can be identified by comparing with spectra of standard samples of iron oxide containing Fe²⁺ (for example, magnetite) and iron oxide containing only Fe³⁺ (for example, hematite and maghemite).

At this time, the measurement conditions of EPMA are acceleration voltage: 7 kV, measurement diameter: 50 um, beam current: 30 nA and measurement time: 1 sec/step.

### (6) The Orientation and Molding

Magnetic materials using the composite magnetic material for a magnet according to the present invention are used for various applications by solidifying only a rare earth-iron-nitrogen based magnetic material surface-coated with the ferrite based magnetic material, or by adding a metal binder, another magnetic material and a resin thereto and molding the mixture, or otherwise. Particularly if a resin described above is blended, it makes the magnetic material-resin composite material according to the present invention. In the case where the composite magnetic material for a magnet according to the present invention is an anisotropic material, if the magnetic field orientation operation is carried out at least once in the molding process, a magnet having high magnetic characteristics is made, which is especially recommended.

Methods for solidifying only the composite magnetic material for a magnet according to the present invention include a method in which the material is putting in a mold, and powder-compacted in cold for use as it is, and also a method in which successively, the molding is subjected to rolling in cold, forging, shock wave compression molding or the like for molding, but in many cases, the method involves sintering the material for molding while subjecting it to a heat treatment at a temperature of 50° C. or higher. The heat treatment atmosphere is preferably a non-oxidizing atmosphere, and the heat treatment is favorably carried out in an inert gas including rare gas such as argon or helium or nitrogen gas, or in a reducing gas including hydrogen gas. The heat treatment, under the temperature condition of 500° C. or lower, can be carried out even in the air. The sintering may be carried out at ordinary pressure or under a pressurization or even in vacuum.

This heat treatment may be carried out simultaneously with the powder compaction, and the magnetic material according to the present invention can be molded also by a pressure sintering such as hot pressing, HIP (hot isostatic pressing) and further SPS (spark plasma sintering). In order to make large the pressurization effect to the present invention, the applied pressure in the heating and sintering process needs to be in the range of 0.0001 to 10 GPa. With the pressure of less than 0.0001 GPa, since the effect of the pressurization is poor and electrical and magnetic characteristics do not make a difference from those in atmospheric sintering, the pressure sintering is disadvantage corresponding to a dropped productivity. With that exceeding 10 GPa, since the pressurization effect saturates, an excessive pressurization only drops the productivity, which makes no significance.

There is a possibility that a large pressurization induces undesirable cracks to a magnetic material to worsen a high electrical resistivity the magnetic material intrinsically has. Therefore, the range of applied pressure is preferably 0.001 to 1 GPa, and more preferably 0.01 to 0.1 GPa.

Among hot press methods, the ultrahigh pressure HP method in which hot press is carried out by placing a powder-compacted body in a capsule undergoing plastic deformation and then heat treating while applying a large pressure from the uni- to triaxial directions, different from a hot press method in which the pressure heat treatment is carried out in a hard metallic or carbon mold using a uniaxial compression machine, can apply a pressure of 2 GPa or higher, which is hardly applied even using a tungsten carbide hard metallic mold, to a magnetic material with no trouble of breakage of the metallic mold and the like, and moreover isotropically, and additionally can suppress the transpiration of volatile components without being mingled with impurities such as oxygen because the pressure plastically deforms the capsule and encloses the interior to enable molding without contact with air.

In many of the above methods, the solidification is often achieved slightly accompanied by the decomposition of the magnetic material surface, but among shock wave compression methods, the well-known in-water shock wave compression method is advantageous as a method capable of molding a magnetic material without decomposition of the magnetic material.

Then, as an example in which the composite magnetic material for a magnet according to the present invention is molded to make a magnet, the in-water shock wave compression will be described in detail. However, the manufacturing method according to the present invention is not limited thereto.

The shock wave compression method by in-water shock waves can be selected from: a method in which the powder is powder-compacted in the innermost portion of a double tube, water is put in the intermediate portion, an explosive is disposed in the outer circumferential portion, and by detonating the explosive, shock waves are introduced into water in the intermediate portion and the powder in the innermost portion is compressed; a method in which the powder is powder-compacted in an enclosed vessel, and the vessel is placed in water, and an explosive is detonated in water and the powder is compressed by the shock waves; and a method according to Japanese Patent No. 2951349 (hereinafter, referred to as “PATENT DOCUMENT 5”) or Japanese Patent No. 3220212 (hereinafter, referred to as “PATENT DOCUMENT 6”). Any method thereof can provide an advantage of impact compression by in-water shock waves as described below.

In the compression solidification process by the impact compression method using in-water shock waves according to the present invention, the ultrahigh pressure shearing property and the activation action which shock waves have induce the solidifying action by a metallic bond of a powder and the micronizing action of a texture to enable the bulk solidification. At this time, although the sustaining time of the impact pressure itself is longer than the case of using conventional shock waves, the temperature rise due to an increase in the entropy based on a volume compression and a nonlinear phenomenon of shock waves vanishes in a very short time (several microseconds or less) to cause almost no decomposition and denitrification. The residual temperature is present also after the compression using the in-water shock wave. If the residual temperature reaches the decomposition temperature (about 650° C. or higher at ordinary pressure), the decomposition of a rare earth-iron-nitrogen based magnetic material starts and deteriorates magnetic characteristics, which is not preferable. However, the case of using the in-water shock wave can hold the residual temperature at a low temperature more easily than the case of using conventional shock waves. As examples in which a rare earth-iron-nitrogen based magnetic material is solidified by the in-water shock wave method, there are JP 2002-329603 A (hereinafter, referred to as “PATENT DOCUMENT 7”) and A. Chiba, K. Hokamoto, S. Sugimoto, T. Kozuka, A. Mori and E. Kakimoto, J. Magn. Magn. Mater., 310, E881 (2007) (hereinafter, referred to as “NON-PATENT DOCUMENT 6”).

The method in which a composite magnetic material is added with a metal and molded by one of the methods described above is especially effective as a method for solidifying the composite magnetic material without decomposing it. The metal is preferably a low melting point one, such as Zn, In, Sn or Ga, whose melting point is 1,000° C. or lower, and preferably 500° C. or lower. Above these all, use of Zn remarkably enhances the coercive force and its thermal stability. In the case where the surface coating ratio of a ferrite based magnetic material to a rare earth-iron-nitrogen based magnetic material is in the range of 50 to 99.9%, the addition of Zn is especially effective. It is possible that the magnetic material is mixed with a ferromagnetic element such as Fe, Co or Ni or a cubic metal element such as Al, V, Cr, Mn, Cu, Zn, Nb, Mo, Ag, Sn, Ta, W, Ir, Pt, Au or Pb, powder-compacted, sintered and rolled.

However, too much addition of these metal binders inhibits a high electrical insulation imparted by the introduction of a ferrite coating layer, which is not preferable.

The additional amount, depending on the thickness of the ferrite coating layer, needs to be restricted in the range of 0.01 to 30 mass %. The more preferable range of the addition is 0.1 to 10 mass %. The addition of less than 0.01 mass % hardly exhibits an effect on easy moldability of the metal binder.

In the case where the composite magnetic material powder obtained in (5) described above is applied to a magnetic material-resin composite material for a magnet, the magnetic material powder is molded by mixing the magnetic material powder with a thermosetting resin or a thermoplastic resin and then compression molding the mixture, or kneading that together with a thermoplastic resin and then injection molding the mixture, or further by extrusion molding, roll molding, calender molding or the like.

Orientation methods include mechanical methods and magnetic field orientation. In the case of using a magnetic powder having a high flatness ratio, utilizing the anisotropy of the shape, mechanical orientation is possible by devising a way of applying pressure and the like. Since a one-dimensional pressure is applied in roll molding and a two-dimensional pressure is applied in compression molding, the anisotropy of a composite magnetic material or a magnetic material-resin composite material after orientation changes corresponding to molding methods, depending on shapes of magnetic powders.

When a composite magnetic material for a magnet is singly molded or a magnetic material-resin composite material is molded by the method described above, if a part or the whole of the processes are carried out in a magnetic field, magnetic particles are magnetically oriented and magnetic characteristics are largely improved in some cases. Such a large improvement is seen in the case where the composite magnetic material for a magnet according to the present invention is an anisotropic material. The magnetic coupling method according to the present invention can easily provide an anisotropic composite magnetic material for a magnet whose magnetic field orientation is effective, and is one of features of manufacturing methods in the present invention. Methods of magnetic field orientation include three types of uniaxial magnetic field orientation, rotating magnetic field orientation and opposing magnetic poles orientation.

“The uniaxial magnetic field orientation” refers to that a static magnetic field is applied usually in an optional direction from the outside to a magnetic material or a magnetic material-resin composite material in a movable state to align the easy magnetization direction of the magnetic material to the external static magnetic field. A uniaxial magnetic field oriented mold is usually fabricated by thereafter applying a pressure, solidifying the resin component or otherwise.

“The rotating magnetic field orientation” refers to a method in which a composite magnetic material or a magnetic material-resin composite material in a movable state is usually put in an external magnetic field rotating in one plane to align the hard magnetization direction of the magnetic material to one direction. The rotating methods involve a method in which an external magnetic field is rotated, a method in which a magnetic material is rotated in a static magnetic field, a method in which the intensities of a plurality of magnetic poles are synchronously changed to apply a magnetic field at all times by assembling such a sequence as if the magnetic material were subjected to a rotating magnetic field, although no external magnetic field or magnetic material is rotated, and other methods. In extrusion and roll forming, a method, in which two or more magnetic poles are arranged in the extrusion direction and the intensities or polarities of the magnetic field are changed so that a composite magnetic material or a magnetic material-resin composite material is oriented by such a way as if it were subjected to a rotating magnetic field when the material passes, is also a rotating magnetic field orientation in a broad sense.

The opposing magnetic poles orientation is a method in which a magnetic material or a magnetic material-resin composite material is statically placed, or rotated or translated in an environment where magnetic poles of the same polarity face each other to align the hard magnetization direction to one direction. A method called radial orientation is the same as the opposing magnetic poles orientation in the principle, and is generally executed by effectively combining a magnetic mold and a nonmagnetic mold in order to exactly control the magnetic path direction penetrating a magnetic material during molding

The magnetic field molding is carried out, in order to magnetically orienting fully a composite magnetic material, in a magnetic field preferably 0.01 T or higher, more preferably 0.1 T or higher, and most preferably 0.5 T or higher. The intensity and the time of a magnetic field necessary for the magnetic field orientation depend on the shape of a magnetic powder, and in the case of a magnetic material-resin composite material, the viscosity of a matrix and the affinity for a magnetic powder.

Generally, since use of a stronger magnetic field gives a shorter orientation time, for the magnetic field orientation in roll molding and calender molding, which have a short molding time and use a matrix resin having a high viscosity, the magnetic field of 0.5 T or higher is desirably used.

The manufacturing method of the composite magnetic material or the magnetic material-resin composite material more preferably uses processes in which a mother alloy of an R—Fe component composition is prepared by the method exemplified in (1), or (1) and (2); the alloy is nitrided by the method indicated in (3); the resultant is micropulverized by the method indicated in (4); the resultant is the surface coated with a soft magnetic ferrite based magnetic material having a spinel structure by the method indicated in (5); and the resultant is magnetically oriented as indicated in (6).

### EXAMPLES

Hereinafter, the present invention will be described further specifically by way of Examples and the like, but the scope of the present invention is not any more limited to these Examples and the like. Evaluation methods in the present invention were as follows.

### (1) The Magnetic Characteristics

A molding of a rare earth-iron-nitrogen based magnetic material, a composite magnetic material or a magnetic material-resin composite material was magnetized at room temperature at 6 T and a demagnetization curve was drawn using a vibrating sample magnetometer (VSM). Based on this, the residual magnetic flux density Bᵣ(T), the intrinsic coercive force μ₀H_{cJ}(T), and the maximum energy product (BH)ₘₐₓ (J/m³) at room temperature were determined. In the Example, when the value of the magnetization measured as described above had no inflection point on the magnetization curve in the range of a low magnetic field range (0 to 0.5 T), a magnetic coupling was defined as being achieved.

### (2) The Electrical Resistivity

A molding of a rare earth-iron-nitrogen based magnetic material, a composite magnetic material or a magnetic material-resin composite material was measured for the electrical resistivity by the four-terminal method. In the Example, when the electrical resistivity was 2,500 μΩcm or higher, the electrical insulation was defined as being achieved. However, the preferable range of the electrical resistivity is 3,500 μΩcm or higher.

### (3) The Nitrogen Content and the Oxygen Content

The nitrogen content and the oxygen content were quantified with Si₃N₄ (containing a specified amount of SiO₂) as a standard sample by the inert gas fusion in pulse furnace.

### (4) The Average Particle Diameter of a Rare Earth-Iron-Nitrogen Based Material

An equivalent-volume diameter distribution was measured using a laser diffraction type particle size distribution analyzer and the average particle diameter was evaluated as a median diameter (μm) determined from a distribution curve thereof.

### (5) The Coating Thickness of a Ferrite Based Magnetic Material

The cross-section of a composite magnetic material was observed by a scanning electron microscope (SEM) or a transmission electron microscope (TEM) to determine each magnetic material component and the void content together using results of the density measurement. The approximate thickness was confirmed as a value half a difference between average particle diameters, of (4) described above, determined before and after ferrite coating.

### (6) The Oxidation-Resistant Performance

A magnetic material was put in a thermostatic chamber held at 110° C., and left in the air for 200 hours; and thereafter, the intrinsic coercive force was measured, and the ratio to the initial intrinsic coercive force was taken to determine its holding ratio (%). In the Example, a material having an oxidation-resistant performance of 80% or more was defined as a material excellent in the oxidation resistance.

### Example 1

Sm of 99.9% in purity and Fe of 99.9% in purity were melted and mixed in an arc melting furnace in an argon gas atmosphere to fabricate an ingot. The ingot was annealed in an argon atmosphere at 1,150° C. for 20 hours, slowly cooled, and subjected to a surface polishing to prepare an alloy having a composition of Sm_{10.6}Fe_{89.4}.

The alloy was pulverized by a jaw crusher, and then further pulverized by a cutter mill in an argon atmosphere, and the particle size was regulated by a sieve to obtain a powder of approximately 60 μm in average particle diameter. The Sm—Fe alloy powder was charged in a horizontal tubular furnace, and subjected to a heat treatment at 450° C. in a mixed gas flow having an ammonia partial pressure of 0.35 atm and a hydrogen gas partial pressure of 0.65 atm for 2 hours, and further annealed in an argon gas flow for 30 min to adjust the alloy powder to a SM_{9.0}Fe_{76.1}N_{14.9} composition of approximately 30 μm in average particle diameter.

Then, the magnetic powder obtained as described above was pulverized in hexane in a rotary ball mill for 4 hours to fabricate a fine rare earth-iron-nitrogen based magnetic material of approximately 2 μm in average particle diameter. The material was measured by the X-ray diffractometry to reveal that the material had a rhombohedral crystal structure.

The material was charged together with purified water in a reactor, and surface-treated with an acid; thereafter, while the material was again vigorously stirred in the air to such a degree that the material was fully dispersed in the purified water, a 280 mM potassium hydroxide aqueous solution (pH adjustment solution) was dropwise charged to gradually shift and adjust pH of the system from an acidic side to an alkali side in the range of 6.1 to 11.8, and a 126 mM FeCl₂ aqueous solution (reaction solution) was simultaneously dropwise charged and reacted for 10 min; then the dropping of the pH adjustment solution and the reaction solution was stopped, and the stirring operation was continued further for 10 min. Thereafter, the dispersion was washed with purified water and then with acetone to remove components liberated from the rare earth-iron-nitrogen based magnetic material. The ferrite coating treatment by this ferrite plating method provided a composite magnetic material for a magnet being a rare earth-iron-nitrogen based magnetic material having a ferrite coating layer of Sm_{7.7}Fe_{71.1}N_{12.6}O_{8.6} of approximately 2.1 μm in average particle diameter. As a result of an electron beam diffractometry and the EPMA measurement thereof, the ferrite coating layer was revealed to be an intermediate phase of magnetite and maghemite.

The composite magnetic material for a magnet was blended with 2 mass % of an epoxy resin, molded at an orientation magnetic field of 1.5 T at 1 GPa, and cured to obtain a compression-molded bond magnet, whose magnetic characteristics and electrical resistivity were measured. The results are shown in Table 1. No inflection point was found on the magnetization curve in the low magnetic field region, and the electrical insulation and the magnetic coupling were found to be achieved. The thickness of the ferrite coating layer was about 40 nm. The density and the filling factor of the compression-molded bond magnet were 5.62 g/cm³ and 77% by volume. The oxidation-resistant performance of the compression-molded bond magnet was 85% and the composite magnetic material for a magnet was found to have an excellent oxidation-resistant performance.

### Comparative Example 1

A compression-molded bond magnet using the rare earth-iron-nitrogen based magnetic material was fabricated as in Example 1, except for not carrying out the ferrite coating treatment. The compression-molded bond magnet was measured for the magnetic characteristics and the electrical resistivity, and the results shown in Table 1 were obtained. The density and the filling factor of the compression-molded bond magnet were 5.89 g/cm³ and 77% by volume.

The compression-molded bond magnet had slightly higher magnetic characteristics but lower electrical resistivity than those in Example 1, thus not achieving the electrical insulation. The compression-molded bond magnet had an oxidation-resistant performance of 65%, which was considerably lower than that in Example 1. From these results, the composite magnetic material for a magnet according to the present invention was found to have an improved oxidation-resistant performance as a result of the incorporation of a ferrite coating layer.

### Example 2

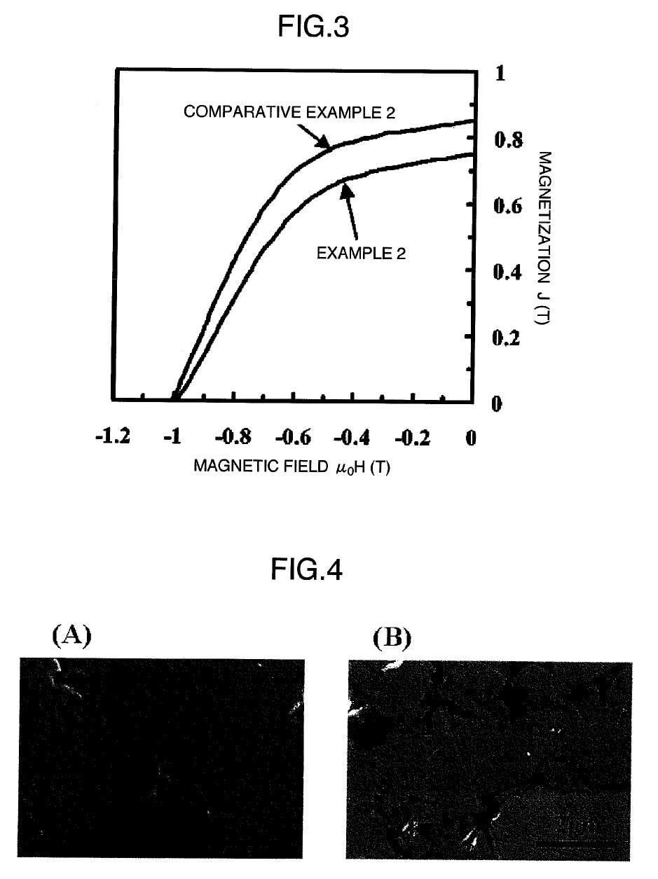

A rare earth-iron-nitrogen based magnetic material of a Sm_{9.1}Fe_{77.3}N_{13.6} composition having an average particle diameter of about 2 μm and a rhombohedral crystal structure was obtained as in Example 1. Then, the magnetic material powder was subjected to the same ferrite coating treatment as in Example 1, but under the altered condition where the reaction time was set at 20 min while the pH of the system was adjusted so as to gradually shift from an acidic side to an alkali side in the range of 4.6 to 13.8, to obtain a composite magnetic material for a magnet of a Sm_{7.5}Fe_{71.6}N_{11.3}O_{9.6} composition. The SEM photographs of the composite magnetic material and the rare earth-iron-nitrogen based magnetic material before the ferrite coating treatment are shown in FIG. 2. (A) is a SEM photograph of the rare earth-iron-nitrogen based magnetic material powder before the ferrite coating treatment; and (B) is a SEM photograph of the composite magnetic material powder after the ferrite coating treatment. From these photographs, the state is found that the surface of the rare earth-iron-nitrogen based magnetic material powder having a diameter of about 2 μm was almost completely coated with the ferrite based magnetic material having a particle diameter of about 10 nm or less. The magnetic characteristics and the electrical resistivity of a magnet obtained by powder-compacting the composite magnetic material at an orientation magnetic field of 1.5 T at 1 GPa are shown in Table 1. The electrical resistivity reached 7,490 μΩcm, sufficiently exceeding 2,500 μΩcm as a standard of the electrical insulation. In FIG. 3, the demagnetization curve of the powder-compacted magnet is shown. No inflection point was found on the magnetization curve in the low magnetic field region, and the electrical insulation and the magnetic coupling were confirmed to be achieved. The density and the filling factor of the powder-compacted magnet were 5.31 g/cm³ and 73% by volume, respectively. The thickness of the ferrite coating layer was about 50 nm.

### Comparative Example 2

A pressure-powder molded magnet using the rare earth-iron-nitrogen based magnetic material was fabricated as in Example 2, except for not carrying out the ferrite surface coating treatment. The powder-compacted magnet was measured for the magnetic characteristics and the electrical resistivity, and the results shown in Table 1 were obtained. The density and the filling factor of the powder-compacted molded magnet were 5.35 g/cm³ and 70% by volume. In FIG. 3, the demagnetization curve of the powder-compacted magnet is shown.

As compared with Example 2, the magnet had good magnetic characteristics but had a by far bad electrical resistivity of 1,730 μS/cm, which means no electrical insulation.

### Example 3 and Comparative Example 3

The composite magnetic material powder for a magnet used in Example 2 and the rare earth-iron-nitrogen based magnetic material powder used in Comparative Example 2 were each subjected to the in-water shock wave compression molding by a well-known method (a method described in PATENT DOCUMENT 7). The applied pressure at this time was 6 GPa. The magnetic material as a raw material was molded with a magnetic field never applied so as to make an isotropic magnet. The density and the filling factor of the shock wave compression-molded magnet (Example 3) using the composite magnetic material for a magnet in Example 2 were 6.84 g/cm³ and 94% by volume; and the density and the filling factor of the shock wave compression-molded magnet (Comparative Example 3) using the magnetic material in Comparative Example 2 were 7.07 g/cm³ and 92% by volume. FIG. 4(A) is a SEM photograph of the cross section of the shock wave compression-molded magnet in Comparative Example 3; and FIG. (B), the cross section of the shock wave compression-molded magnet using the composite magnetic material in Example 3. In (A), only the rare earth-iron-nitrogen based magnetic material was present and only grain boundaries dividing crystal grains were present. In (B), the ferrite coating layer was present as a grain boundary phase of the rare earth-iron-nitrogen based magnetic material, and had a thickness of 50 nm. Further by the SEM measurement, it was revealed that the volume ratio of the rare earth-iron-nitrogen based magnetic material phase and the ferrite coating layer phase was 85:15.

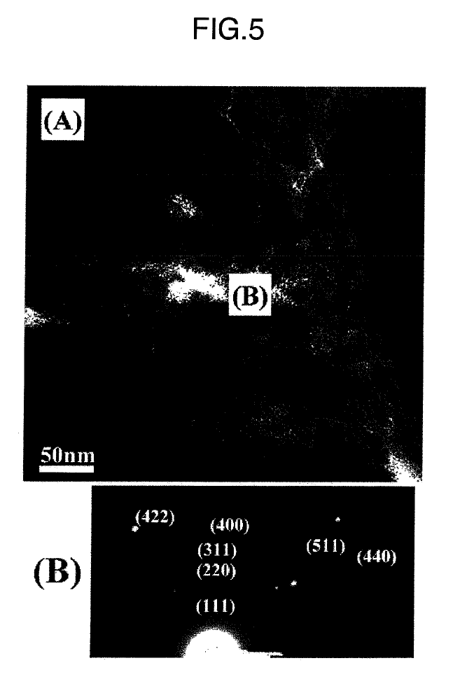

In FIG. 5, a photograph (upper figure (A)) by the TEM observation of the cross section of the shock wave compression-molded magnet in Example 3, and an electron beam diffraction pattern (lower figure (B)) of the grain boundary phase being the ferrite coating layer are shown. In the TEM photograph in the upper figure, a portion of (A) is the rare earth-iron-nitrogen based magnetic material (main phase), and a portion of (B) is the ferrite based magnetic material (grain boundary phase) as a coating material. The electron beam diffraction pattern of the (B) phase of the lower figure is a measurement result when the electron beam was diaphragmed to about 50 nm. All of seven confirmed electron beam diffraction ring patterns were assigned to an Fe ferrite having a spinel structure. The numerical values shown in each ring in the lower figure are Miller indices of the Fe ferrite having a spinel structure. From the results of the EPMA analysis, it was found that a considerable amount of Fe²⁺ was present in the ferrite coating layer; and it was found that the ferrite coating layers of the rare earth-iron-nitrogen based magnetic materials in Examples 2 and 3 were constituted of an intermediate of magnetite and maghemite, which is one type of Fe ferrite having a spinel structure, and the composition was an Fe ferrite magnetic material being very near magnetite.

The magnetic characteristics and the electrical resistivities of these shock wave compression-molded magnets are shown in Table 1. The electrical resistivities are as high as 4,770 μΩcm and the magnetization curve of the shock wave compression-molded magnet in Example 3 had no inflection point in the low magnetic field region, thus confirming that the electrical insulation and the magnetic coupling were achieved. Although the shock wave compression-molded magnet in Comparative Example 3 slightly exceeded that in Example 3 in magnetic characteristics, it had a low electrical resistivity, thus providing no electrical insulation. The reason lies in that as seen in FIG. 4, grain boundaries of the shock wave compression-molded magnet in Comparative Example 3 had no presence of a layer of a high electrical resistivity like the ferrite coating layer to secure the electrical insulation between magnetic material grains, different from the shock wave compression-molded magnet in Example 3.

### Example 4 and Comparative Example 4

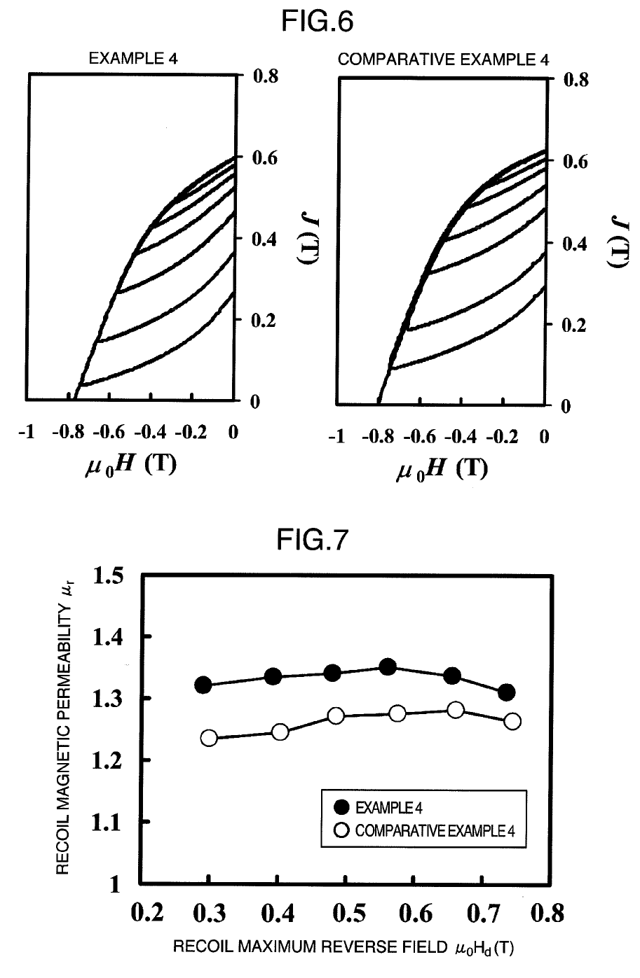

An shock wave compression-molded magnet (Example 4) using the rare earth-iron-nitrogen based composite magnetic material for a magnet coated with ferrite coating and an shock wave compression-molded magnet (Comparative Example 4) using the rare earth-iron-nitrogen based magnetic material fabricated as in Example 3 and Comparative Example 3 were magnetized at a pulse magnetic field of 6 T; a magnetic field was applied in the reversed magnetic field direction to the each magnet and the magnetic field was turned back in the maximum reverse field and returned to 0, thereby drawing a recoil line, which is FIG. 6. The maximum reverse fields had intensities of between 0.2 to μ₀H_{cJ} (T) in increments of 0.1 T; at every time a recoil loop was once drawn in the maximum reverse field, the each magnet was again magnetized, and measured. In FIG. 6, the demagnetization curve of the each magnet magnetized at a pulse magnetic field of 6 T is shown together.

It can be read that if compared in the maximum reverse fields in the same level, the slope of the recoil line of the shock wave compression magnet of the ferrite-plated rare earth-iron-nitrogen based composite magnetic material for a magnet was larger, but slightly, than that of the rare earth-iron-nitrogen based magnetic material. The recoil magnetic permeability is a value approximating the recoil line in a B-H curve to a straight line. The recoil magnetic permeability μᵣ is calculated using the relational equation (1) by measuring a magnetization value J_{d} at the maximum reverse field μ₀H_{d} and a magnetization value J₀ when the magnetic field is returned to a magnetic field 0.

$$\begin{matrix}[ Formula 1 ] & \\ {μ}_{r} = 1 + \frac{{J}_{0} + {J}_{d}}{{μ}_{0} {H}_{d}} & ( 1 )\end{matrix}$$

That is, the recoil magnetic permeability is a value obtained by adding 1 to the slope of the recoil line in the J-H curve in FIG. 6. Therefore, a magnet having a larger slope of the recoil line in the J-H curve has a larger recoil magnetic permeability μᵣ. Then, if a strong bond is generated between soft magnetism and hard magnetism by the exchange interaction, the recoil magnetic permeability becomes larger than that of a hard magnetic single substance.

This is caused by the reason that a reversed magnetic field is applied to an exchange-spring magnet to exert a large external force in the direction of bringing down spins, and even if spins in a soft magnetic phase in the exchange-spring magnet are largely inclined, and if the external force is removed, the spins return to the original state reversibly like a spring mechanism. Since the returning amount of the magnetization is larger in the case where a soft magnetic phase in which the slope of spins in the direction of bringing down of spins by an external force is large is present in a magnet than in the case where that is not present, the recoil magnetic permeability becomes large.

FIG. 7 is a diagram showing comparison of the recoil magnetic permeability in Example 4 with that in Comparative Example 4 with the abscissa indicating a maximum reverse field (effective magnetic field). The magnet in Example 4 was found to have a higher recoil magnetic permeability in the entire range of the maximum reverse field than the magnet in Comparative Example 4.

Therefore, the magnet in Example 4 using the ferrite-coated rare earth-iron-nitrogen based composite magnetic material for a magnet was found to be an exchange-spring magnet.

Comparisons of Example 3 with Comparative Example 3 and Example 4 with Comparative Example 4 revealed that the decreasing rate of the residual magnetic flux density of the shock wave compression magnet was well reproducibly 4%, but taking into consideration that the volume fraction of the ferrite layer was as high as 15% by volume, the decreasing rate can be said to have been suppressed to a considerably low value. To know this cause, the decreasing rate of the residual magnetic flux density by plating was calculated. As described in NON-PATENT DOCUMENT 4, although an amorphous surface oxide layer of about 10 nm is observed in a Sm₂Fe₁₇N₃ micropowder of 2 μm in powder particle diameter, since the detail study result by EPMA has confirmed that the layer is near hematite of Fe³⁺ in electric charge state, and since it has been found that if the specific surface area increases with pulverization, the saturation magnetization decreases, and the decreasing rate of the saturation magnetization is in a volume fraction level of the surface oxide layer, or more than that, at least this layer is considered to be non-magnetic. According to this assumption, the magnetizations of a Sm₂Fe₁₇N₃ and a ferrite-plated Sm₂Fe₁₇N₃ shock wave compression magnets of a 100% filling factor are 1.52 T and 1.40 T, respectively. According to the theory by Stoner and Wohlfarth (see E. C. Stoner and E. P. Wohlfarth, Phil. Trans. Roy. Sci., 240, 599 (1948) (hereinafter, referred to as “NON-PATENT DOCUMENT 7”)), aggregates of single magnetic domain grains disorderly oriented have a residual magnetic flux density being ½ of the saturation magnetization. Since a Sm₂Fe₁₇N₃ and a ferrite-plated Sm₂Fe₁₇N₃ shock wave compression magnets are both isotropic, the magnetic walls do not move to an external magnetic field of 0, and if crystal grains constituting a magnet is held in a single magnetic domain state, the residual magnetic flux densities thereof must be 0.76 T and 0.70 T, respectively. The residual magnetic flux density of an actual magnet has 15 to 24% lower value than this, but in the case of the Sm₂Fe₁₇N₃ shock wave compression magnet in this study, since defects in a magnetic powder are not completely removed, the residual magnetic flux density contains an amount corresponding to the decreasing amount of the residual magnetic flux density by the movement of magnetic walls, so the residual magnetic flux density conceivably exhibits a slightly small value.

Here, it is assumed that the ratio of residual magnetic flux densities in the cases of the presence and absence of plating corresponds to the ratio of the saturation magnetizations.

This is because since characteristics of magnets compressed by shock waves under the same conditions were compared, even if discussion is progressed under the assumption, the discussion will make no mistake in most cases in understanding the phenomenon.

The decreasing rate δ_{obs} of Bᵣ of a ferrite-plated Sm₂Fe₁₇N₃ shock wave compression magnet to a Sm₂Fe₁₇N₃ shock wave compression magnet was calculated by:

δ_{obs}=1−(Bᵣ of a ferrite-plated Sm₂Fe₁₇N₃ magnet)/(Bᵣ of a Sm₂Fe₁₇N₃)

and the calculation became 4%.

Then, the calculation value δ_{calc} of the decreasing rate of the magnetic flux density was determined by the following expression based on the above-mentioned assumption, which became 7%.

$$\begin{matrix}[ Formula 2 ] & \\ {δ}_{calc} = 1 - \frac{\{ {J}_{N} ( 1 - {v}_{SO} ) {v}_{N} + {J}_{O} {v}_{O} \} {η}_{f}}{{J}_{N} ( 1 - {v}_{SO} ) {η}_{S}} & ( 2 )\end{matrix}$$

Here, since the magnetization of the Sm₂Fe₁₇N₃ and the volume fraction of the surface oxide layer of the micropowder were J_{N}=1.52 (T) and νₛₒ=0.03 (since the thickness of the surface oxide layer was 10 nm, in the Sm₂Fe₁₇N₃ micropowder of 2 μM, the volume fraction with respect to the whole of the surface oxide layer was 3%), the magnetization of the ferrite coating layer was J_{O}=0.6 (T), if represented by the magnetization of magnetite; the filling factor of the Sm₂Fe₁₇N₃ shock wave compression magnet was ηₛ=0.92; the filling factor of the ferrite-plated Sm₂Fe₁₇N₃ shock wave compression magnet, and the volume ratio of the Sm₂Fe₁₇N₃ to the ferrite were η_{f}=0.94 and ν_{N}: ν_{O}=0.85:0.15.

Therefore, the value by actual measurement cannot be explained by the above-mentioned calculation.

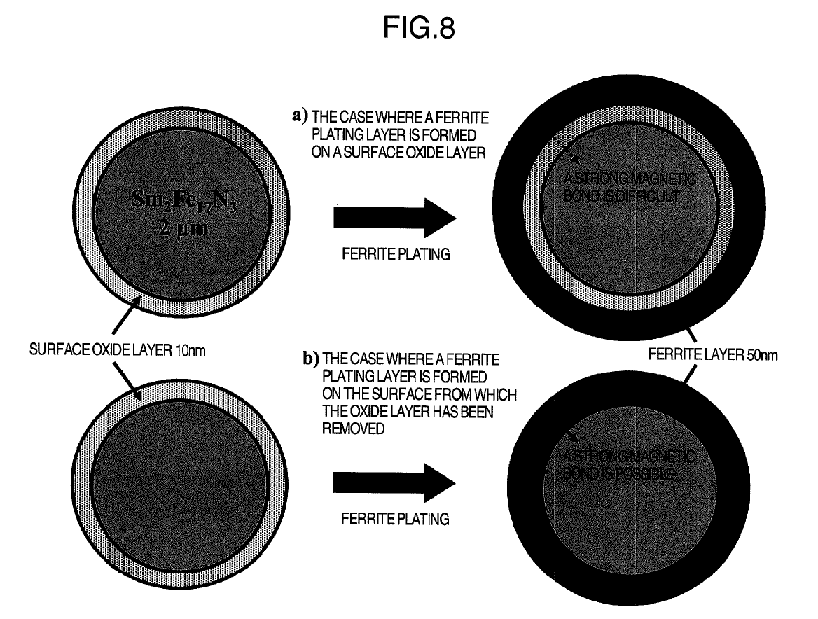

The relational equation (2) is a calculation on the assumption that the ferrite-plated Sm₂Fe₁₇N₃ magnet also contained an oxide layer present on the Sm₂Fe₁₇N₃ micropowder surface. Is this assumption right? From the shape of the demagnetization curve and measurement results of the recoil magnetic permeability, it has been stated that it is conceivable that there was a strong bond between the ferrite phase and the Sm₂Fe₁₇N₃ phase by the exchange interaction and an exchange-spring magnet was made. If a non-magnetic oxide layer was still present in a thickness of 10 nm on the surface of the Sm₂Fe₁₇N₃ micropowder after the ferrite plating, it is not conceivable that a strong magnetic bond by the exchange interaction between the ferrite phase and the Sm₂Fe₁₇N₃ phase, which were separated by this layer, was generated. Therefore, the consideration is reasonable in which the Sm₂Fe₁₇N₃ micropowder surface oxide layer was almost removed in the ferrite plating process to be replaced by the ferrite layer. FIG. 8 is a diagram interpreting the above-mentioned situation. a) is the case where a ferrite plating was formed on the Sm₂Fe₁₇N₃ surface oxide layer; and b) is the case where the Sm₂Fe₁₇N₃ surface oxide layer was etched and removed by the acid treatment in the head of the ferrite plating process, and thereafter, a plating layer was formed directly on the Sm₂Fe₁₇N₃ surface.

If the case of b) is assumed, δ_{calc} is corrected to the relational equation (3).

$$\begin{matrix}[ Formula 3 ] & \\ {δ}_{calc} = 1 - \frac{( {J}_{N} {v}_{N} + {J}_{O} {v}_{O} ) {η}_{f}}{{J}_{N} ( 1 - {v}_{SO} ) {η}_{S}} & ( 3 )\end{matrix}$$

δ_{calc} was calculated based on this equation, which became 4%, which is consist with the actual measurement value δ_{obs}.

From the calculation results of the decreasing rate of the residual magnetic flux density as described above, the oxide layer containing a rare earth element between the ferrite phase and the Sm₂Fe₁₇N₃ phase was nearly 0 nm, thus revealing that the bond by the exchange interaction strongly functioned.

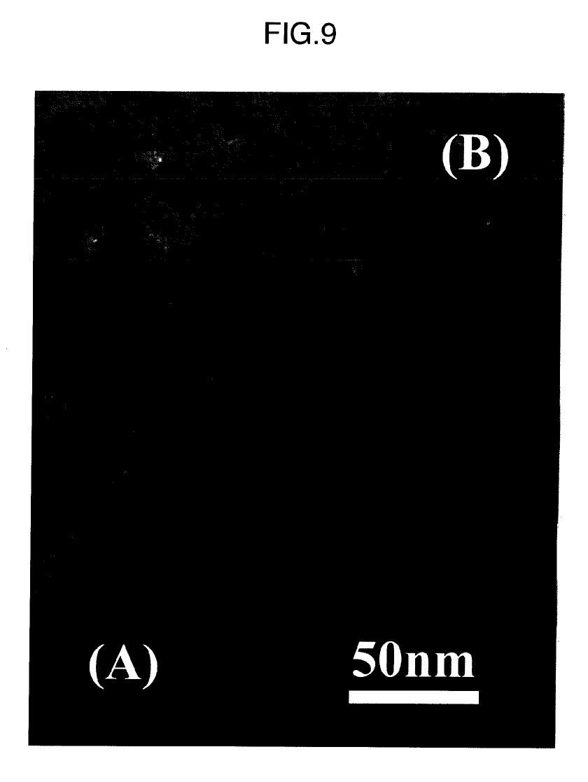

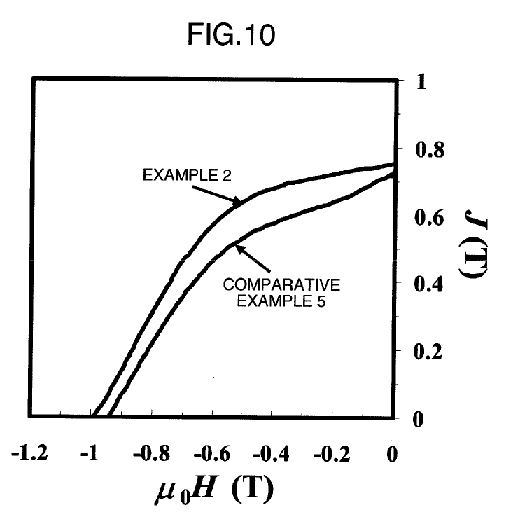

FIG. 9 is a result obtained by actually observing the vicinity of the interface between a ferrite phase and a Sm₂Fe₁₇N₃ phase of the shock wave compression-molded magnet in Example 4 by TEM. In the figure, the portion of (A) was the Sm₂Fe₁₇N₃ phase and the portion of (B) was a ferrite phase. From this photograph, it was confirmed that no oxide layer having been present on the surface of the rare earth-iron-nitrogen based magnetic material raw material powder was present in the range of the observation limit of TEM at the soft magnetic phase-hard magnetic phase interface. This was substantiated by the results of EDX and the electron beam diffraction of the vicinity of the R phase-F phase interface.

In the composite magnetic material for a magnet in the Example, the crystal grain diameter of ferrite grains right after the ferrite plating was as fine as 10 nm or less and 1 nm or more, but it is very important in order to constitute a strong magnetic bond magnet exhibiting good characteristics that the fineness is kept as it is even after the shock wave compression. This must be because if the crystal grain diameter of the ferrite phase is large, magnetic domain walls appear in the soft magnetic phase interior by a small reversed magnetic field and causes a magnetization reversal to largely decrease the coercive force of the whole.

### Comparative Example 5

The rare earth-iron-nitrogen based magnetic material having an average particle diameter of 2 μm fabricated in Example 2 and a magnetite micropowder were added with hexane and mixed in an agate mortar. At this time, the amount of the magnetite added was 15% by volume. A pressure powder was fabricated using the mixed magnetic material as in Example 2 and the measurement results of the magnetic characteristics and electrical resistivity are shown in Table 1. The molding density and the filling factor of the mixed powder of the rare earth-iron-nitrogen based magnetic material and the magnetite were 5.30 g/cm³ and 73% by volume, respectively, and although the composition and the filling factor were the same as in Example 2, the electrical resistivity was 30% and the maximum energy product was 75% and thus very poor results were obtained as compared with the composite magnetic material for a magnet in Example 2.

In FIG. 9, demagnetization curves of Example 2 and Comparative Example 5 are compared.

The demagnetization curve of Comparative Example 5 had an inflection point at a revered magnetic field of near 0.2 T, and so no bond by the exchange interaction was present and an exchange-spring magnet was not made. Therefore, magnetic characteristics were deteriorated due to the mixing of a soft magnetic ferrite. Ferrite based magnetic grains were present only between grains of the rare earth-iron-nitrogen based magnetic powder, and did not coat the rare earth-iron-nitrogen based magnetic material. Therefore, the electrical resistivity was outstandingly small as compared with the composite magnetic material for a magnet in Example 2 in which the rare earth-iron-nitrogen based magnetic powder surface was almost completely coated with the ferrite layer.

### Examples 5 to 7

Composite magnetic materials were obtained by the same method as in Example 1, except for altering the compositions of a rare earth-iron-nitrogen based magnetic material powder and a ferrite coating layer as shown in Table 2. The materials were powder-compacted at an external magnetic field of 1.5 T at an applied pressure of 1.2 GPa; and their magnetic characteristics and electrical resistivities were measured and the results as shown in Table 2 were obtained. The electrical resistivities in all of powder-compacted magnets of the composite magnetic materials exceeded 2,500 μΩcm, achieving the electrical insulation. In Table 2, the particle diameters of the rare earth-iron-nitrogen based magnetic material and the thicknesses of the ferrite coating layer are shown together. From the results of the X-ray diffractometry, it was revealed that all of these composite magnetic materials for a magnet had a rhombohedral crystal structure. The ferrites of the ferrite coating layers were all a magnetic material having a spinel structure.

In all powder-compacted magnets of the composite magnetic materials for a magnet, an inflection point was not found on the magnetization curve in the low magnetic field region, thus confirming that the electrical insulation and the magnetic coupling were achieved.

### Example 8

A composite magnetic material for a magnet of a Sm_{7.5}Fe_{71.6}N_{11.3}O_{9.6} composition was obtained by the same method as in Example 2, except that the rare earth-iron-nitrogen based magnetic material was not subjected to the surface treatment. The magnetic characteristics and the electrical resistivity are shown in Table 1. In the composite magnetic material for a magnet, an oxide layer of the rare earth-iron-nitrogen based magnetic material, having a thickness of about 10 nm, was present between the ferrite phase and the rare earth-iron-nitrogen phase; and the decrease of magnetic characteristics was large and the maximum energy product exhibited a 16% lower value than that in Example 2. A small inflection point was found at near 0.2 T of the demagnetization curve. Further, the electrical resistivity decreased by 55% from that of Example 2. The thickness of the ferrite layer was about 50 nm.

The observation of the composite magnetic material powder for a magnet after the plating in Example 8 by a SEM photograph confirmed that rare earth-iron-nitrogen based magnetic material grains whose surface was coated with the ferrite layer in only about 50% by volume were mixedly present in 50% by volume or less, and that materials such as nonmagnetic iron oxide and iron hydroxide were mixedly present in 50% by volume or less.

TABLE 1

| | | | | | | | | Maximum |
|---|---|---|---|---|---|---|---|---|
| | | Rare earth-iron- | | | | Residual | Intrinsic | energy |
| | Composite | nitrogen based | | | Electrical | magnetic flux | coercive | product |
| | magnetic material | material | | Resin | resistivity | density | force | (BH)ₘₐₓ |
| Examples | composition | composition | Ferrite phase | (% by weight) | ρ (μΩcm) | Bᵣ (T) | μ₀H_{cJ} (T) | (kJ/m³) |
| Example 1 | Sm_{7.7}Fe_{71.1}N_{12.6}O_{8.6} | Sm_{9.0}Fe_{76.1}N_{14.9} | Magnetite- | Epoxy (2) | 8200 | 0.855 | 0.778 | 132 |
| | | | Maghemite | | | | | |
| Comparative | — | Sm_{9.0}Fe_{76.1}N_{14.9} | — | Epoxy (2) | 1980 | 0.910 | 0.824 | 143 |
| Example 1 | | | | | | | | |
| Example 2 | Sm_{7.5}Fe_{71.6}N_{11.3}O_{9.6} | Sm_{9.1}Fe_{77.3}N_{13.6} | Magnetite- | — | 7490 | 0.751 | 0.990 | 102 |
| | | | Maghemite | | | | | |
| Comparative | — | Sm_{9.1}Fe_{77.3}N_{13.6} | — | — | 1730 | 0.853 | 1.01 | 126 |
| Example 2 | | | | | | | | |
| Example 3 | Sm_{7.5}Fe_{71.6}N_{11.3}O_{9.6} | Sm_{9.1}Fe_{77.3}N_{13.6} | Magnetite- | — | 4770 | 0.555 | 0.691 | 44 |
| | | | Maghemite | | | | | |
| Comparative | — | Sm_{9.1}Fe_{77.3}N_{13.6} | — | — | 690 | 0.577 | 0.752 | 49 |
| Example 3 | | | | | | | | |
| Comparative | — | Sm_{9.1}Fe_{77.3}N_{13.6} | Magnetite | — | 2270 | 0.717 | 0.942 | 75 |
| Example 5 | | | | | | | | |
| Example 8 | Sm_{7.5}Fe_{71.6}N_{11.0}O_{9.9} | Sm_{9.1}Fe_{77.3}N_{13.6} | Magnetite- | — | 3340 | 0.701 | 1.00 | 86 |
| | | | Maghemite | | | | | |

TABLE 2

| | | | Particle | |
|---|---|---|---|---|
| | | | diameter of | |
| | | Rare earth-iron- | rare earth-iron- | |
| | Composite | nitrogen based | nitrogen based | |
| | magnetic material | material | material | |
| Examples | composition | composition | (μm) | Ferrite phase |
| Example 5 | Sm_{9.8}Fe_{53.3}Co_{22.9}•Ni_{0.9}N_{9.4}O_{3.7} | Sm_{10.5}Fe_{55.6}•Co_{23.8}N_{10.1} | 1 | Ni-ferrite |
| Example 6 | Sm_{6.8}Fe_{59.6}Mn_{5.5}•N_{17.6}O_{10.5} | Sm_{8.3}Fe_{66.7}Mn_{3.5}•N_{21.5} | 30 | Mn-ferite |
| Example 7 | Sm_{5.8}Ce_{2.4}Fe_{72.4}•Co_{1.8}N_{12.2}O_{5.4} | (Sm_{0.7}Ce_{0.3})_{9.1}•Fe_{77.3}N_{13.6} | 4 | Co-ferrite |

| | Thickness of | | Residual | | Maximum |
|---|---|---|---|---|---|
| | ferrite coating | Electrical | magnetic flux | Intrinsic | energy product |
| | layer | resistivity | density | coercive force | (BH)ₘₐₓ |
| Examples | (nm) | ρ (μΩcm) | Bᵣ (T) | μ₀H_{cJ} (T) | (kJ/m³) |
| Example 5 | 10 | 5970 | 0.932 | 0.652 | 97 |
| Example 6 | 100 | 10300 | 0.697 | 0.974 | 70 |
| Example 7 | 50 | 6710 | 0.859 | 0.511 | 43 |

### INDUSTRIAL APPLICABILITY

The rare earth-iron-nitrogen based magnetic material coated with the ferrite based magnetic material according to the present invention can provide a rare earth-iron-nitrogen based composite magnetic material for a magnet which can achieve the electrical insulation and the magnetic coupling, has high magnetic characteristics and a high electrical resistivity, which are contrary to each other in conventional oxide materials and metal based materials, and excels in the oxidation-resistant performance.

The present invention is mainly used for various types of actuators, voice coil motors, linear motors, rotors and stators of motors for rotary machines, magnetic field generating sources of medical apparatuses and metal sorting machines, magnetic field generating sources for analyzers such as VSM apparatuses, ESR apparatuses and accelerators, magnetron traveling wave tubes, OA devices such as printer heads and optical pickups, undulators, wigglers, retarders, magnet rolls, magnet chucks, various types of magnet sheets and the like. The present invention is especially used for motors and electric generators whose rotation speed exceeds 500 rpm for driving cars such as electric cars, fuel cell cars and hybrid cars; machine tools; electric generators; motors for industrial machines such as various types of pumps; and motors for home electrical products such as air conditioners, refrigerators and cleaners.

1. A composite magnetic material for a magnet, comprising a rare earth based magnetic material and a ferrite based magnetic material coated on a surface of the rare earth based magnetic material.

2. The composite magnetic material for a magnet according to claim 1, wherein the ferrite based magnetic material is a soft magnetic ferrite.

3. The composite magnetic material for a magnet according to claim 1 or 2, wherein the ferrite based magnetic material is a ferrite having a spinel structure.

4. The composite magnetic material for a magnet according to claim 1, wherein the ferrite based magnetic material has a thickness of 0.8 to 10,000 nm.

5. The composite magnetic material for a magnet according to claim 1, wherein the rare earth based magnetic material is a rare earth-iron-nitrogen based magnetic material.

6. The composite magnetic material for a magnet according to claim 5, wherein the rare earth-iron-nitrogen based magnetic material is a magnetic material represented by the following general formula:
RₓFe_{(100-x-y)N}_{y}
wherein R is at least one of rare earth elements containing Y; and x and y satisfy 3 atomic %<x<30 atomic % and 1 atomic %<y<30 atomic %, respectively.

7. The composite magnetic material for a magnet according to claim 6, wherein 0.01 to 50 atomic % of Fe in the general formula is substituted with at least one element selected from the group consisting of Co, Ni, B, Al, Ti, V, Cr, Mn, Cu, Zn, Ga, Zr, Nb, Mo, Pd, Ag, Cd, In, Sn, Hf, Ta, W, Ru, Re, Os, Ir, Pt, Pb, Bi, an alkali metal and an alkaline earth metal.

8. The composite magnetic material for a magnet according to claim 6 or 7, wherein 50 atomic % or more of R in the general formula is Sm.

9. The composite magnetic material for a magnet according to claim 5, wherein a crystal structure of a main phase of the rare earth-iron-nitrogen based magnetic material is any one of hexagonal crystal, rhombohedral crystal and tetragonal crystal.

10. The composite magnetic material for a magnet according to claim 5, wherein the rare earth-iron-nitrogen based magnetic material is a powder having an average particle diameter of 0.1 to 2,000 μm.

11. The composite magnetic material for a magnet according to claim 1, which is an exchange-spring magnet.

12. The composite magnetic material for a magnet according to claim 5, wherein a phase simultaneously containing R and oxygen in an interface between a layer composed of the ferrite based magnetic material and the rare earth-iron-nitrogen based magnetic material has a thickness of less than 10 nm.

13. The composite magnetic material for a magnet according to claim 5, wherein a layer composed of the ferrite based magnetic material in the composite magnetic material for a magnet is formed on a surface of the rare earth-iron-nitrogen based magnetic material by a ferrite plating method.

14. A magnetic material-resin composite material for a magnet, comprising 5 to 99.9 mass % of the composite magnetic material for a magnet according to claims 1, 2, 5 or 6 and 0.1 to 95 mass % of a resin.

15. A method for manufacturing a ferrite-plated rare earth-iron-nitrogen based composite magnetic material for a magnet, comprising the steps of
subjecting a magnetic material of a rare earth-iron-nitrogen based magnetic material represented by the following general formula:
RₓFe_{(100-x-y)N}_{y}
(wherein R is at least one of rare earth elements containing Y; 50 atomic % or more of R is Sm; and x and y satisfy 3 atomic %<x<30 atomic % and 1 atomic %<y<30 atomic %, respectively),
to an acid treatment with an acidic aqueous solution; and successively,
dispersing the magnetic material in water without being brought into direct contact with air, further successively shifting pH of the dispersion solution from acidity to basicity with a basic aqueous solution, simultaneously adding an aqueous solution containing at least divalent iron ions thereto, mixing and stirring the dispersion solution under an atmosphere containing oxygen, and thereby carrying out a ferrite plating.

16. A method for manufacturing the material according to claim 1, wherein the material is at least once magnetically oriented using an external magnetic field.
